(19) United States
(12) Patent Application Publication
(10) Pub. No.: US 2024/0339600 A1
(43) Pub. Date: Oct. 10, 2024

(54) SOLID-STATE BATTERY NEGATIVE ELECTRODE AND SOLID-STATE BATTERY

(71) Applicant: Panasonic Holdings Corporation, Osaka (JP)

(72) Inventors: Mitsuhiro MURATA, Hyogo (JP); Yoshimi OHZAWA, Aichi (JP); Tomokazu FUKUTSUKA, Aichi (JP)

(21) Appl. No.: 18/746,993

(22) Filed: Jun. 18, 2024

Related U.S. Application Data
(63) Continuation of application No. PCT/JP2022/040028, filed on Oct. 26, 2022.

(30) Foreign Application Priority Data
Dec. 22, 2021 (JP) 2021-207990

(51) Int. Cl. H01M 4/36; H01M 4/02; H01M 4/587; H01M 4/62; H01M 10/0525; H01M 10/0562

(52) U.S. Cl. CPC H01M 4/366; H01M 4/587; H01M 4/62; H01M 4/628; H01M 10/0525; H01M 10/0562; H01M 2004/021; H01M 2004/027; H01M 2300/0068

(57) ABSTRACT

A solid-state battery negative electrode of the present disclosure includes a negative electrode active material layer, the negative electrode active material layer including a solid electrolyte, and a coated active material having a negative electrode active material and a carbon material coating at least a part of a surface of the negative electrode active material. When a Raman spectrum of the coated active material is measured by Raman spectroscopy, a ratio R_{D/G} of an integrated intensity of D band to an integrated intensity of G band is 1.5 or more. A solid-state battery of the present disclosure includes: a positive electrode; a negative electrode; and a solid electrolyte layer disposed between the positive electrode and the negative electrode. The negative electrode is the solid-state battery negative electrode of the present disclosure.

This application is a continuation of PCT/JP2022/040028 filed on Oct. 26, 2022, which claims foreign priority of Japanese Patent Applications No. 2021-207990 filed on Dec. 22, 2021, the entire contents of both of which are incorporated herein by reference.

### BACKGROUND OF THE INVENTION

### 1. Field of the Invention

The present disclosure relates to a solid-state battery negative electrode and a solid-state battery.

### 2. Description of Related Art

In recent years, research and development have been actively conducted on all-solid-state batteries using a solid electrolyte.

Some lithium-ion secondary batteries using an electrolyte solution used in many fields use a graphite particle as a negative electrode active material. For example, JP 4045438 B discloses a two-layer carbon material in which a part or the entirety of an edge portion of a crystal of a core graphite material is coated with a coat-forming carbon material composed of coal-based or petroleum-based tar or pitch. JP 6507395 B discloses a carbonaceous substance-coated graphite particle obtained by coating a spheroidized natural graphite particle with a carbonaceous substance made from coal tar pitch that is the starting material. Carbon Journal of Carbon Research 2017, 3, 22 discloses a coated graphite particle coated with an amorphous carbon using sucrose as a precursor.

### SUMMARY OF THE INVENTION

The present disclosure provides a technique in order both to reduce an irreversible capacity resulting from the reductive decomposition of a solid electrolyte and to improve load characteristics.

A solid-state battery negative electrode of the present disclosure includes
a negative electrode active material layer, the negative electrode active material layer including a solid electrolyte, and a coated active material having a negative electrode active material and a carbon material coating at least a part of a surface of the negative electrode active material, wherein
when a Raman spectrum of the coated active material is measured by Raman spectroscopy,
a ratio R_{D/G} of an integrated intensity of D band to an integrated intensity of G band is 1.5 or more.

The present disclosure can provide a technique in order both to reduce an irreversible capacity resulting from the reductive decomposition of a solid electrolyte and to improve load characteristics.

### BRIEF DESCRIPTION OF THE DRAWINGS

FIG. 1 is a cross-sectional view schematically showing the configuration of a solid-state battery negative electrode of Embodiment 1.

FIG. 2 is a cross-sectional view schematically showing the configuration of a coated active material of Embodiment 1.

FIG. 3 is a graph showing a Raman spectrum of a spheroidized natural graphite coated using petroleum pitch as a carbonaceous substance precursor, and an example of peak fitting thereof.

FIG. 4 is a cross-sectional view schematically showing the configuration of a solid-state battery of Embodiment 2.

FIG. 5 is a cross-sectional view schematically showing the configuration of a half cell used in EXAMPLES.

FIG. 6 is a graph showing the Cole-Cole plot obtained by an impedance measurement of the half cell of Example 1 at a room temperature (25° C.), together with peak fitting thereof.

FIG. 7 is a diagram showing an equivalent circuit of the half cell shown in FIG. 5.

FIG. 8 is a graph showing the results obtained by measuring a reaction resistance at −20° C. in Comparative Example 1 and Example 1.

FIG. 9 is a graph showing the results obtained by measuring a reaction resistance at 0° C. in Comparative Example 1 and Example 1.

FIG. 10 is a graph showing the results obtained by measuring a reaction resistance at 25° C. in Comparative Example 1 and Example 1.

FIG. 11 is a graph showing the results obtained by measuring a reaction resistance at 60° C. in Comparative Example 1 and Example 1.

FIG. 12 is a graph showing a relation between a cumulative irreversible capacity and a geometric specific surface area in Comparative Example 1 to Comparative Example 6 and Example 1 to Example 3.

FIG. 13 is a cross-sectional view schematically showing the configuration of a laminated battery used in EXAMPLES.

FIG. 14 is a graph showing the results of a charge rate test at 60° C. in Comparative Example 7, Comparative Example 8, Example 4, and Example 5.

FIG. 15 is a graph showing the results of a charge rate test at 50° C. in Comparative Example 7, Comparative Example 8, Example 4, and Example 5.

FIG. 16 is a graph showing the results of a charge rate test at 40° C. in Comparative Example 7, Comparative Example 8, Example 4, and Example 5.

FIG. 17 is a graph showing the results obtained by measuring a reaction resistance at 25° C. in Comparative Example 9, Comparative Example 10, Example 6, and Example 7.

FIG. 18 is a graph showing a relation between a reversible capacity and a ratio of a mass of a carbon material to a mass of a coated active material in Comparative Example 2, Comparative Example 6, Comparative Example 11, Example 2, and Example 3.

FIG. 19 is a graph showing a relation between a reversible capacity and a ratio R_{D/G} in Comparative Example 2, Comparative Example 6, Comparative Example 11, Example 2, and Example 3.

### DETAILED DESCRIPTION

(Findings on which the Present Disclosure is Based)

Lithium-ion secondary batteries are composed of a positive electrode, a negative electrode, and an electrolyte disposed between them. The electrolyte is a non-aqueous liquid or solid. Since widely used electrolyte solutions are combustible, lithium-ion batteries using an electrolyte solution (hereinafter referred to as a liquid-based lithium-ion secondary battery) need to be equipped with a system for ensuring safety. In contrast, since solid electrolytes, such as a solid oxide electrolyte and a solid sulfide electrolyte, are incombustible or flame-retardant, lithium-ion secondary batteries using a solid electrolyte (hereinafter referred to as all-solid-state lithium-ion secondary batteries) make it possible to simplify such a system. Therefore, various kinds of all-solid-state lithium-ion secondary batteries are proposed.

The liquid-based lithium-ion secondary batteries are significantly different from the all-solid-state lithium-ion secondary batteries in terms of the mechanism of a reductive decomposition reaction of the electrolyte in the initial charge process.

Carbon TANSO 2002 [No. 203] 136-140 discloses the results of an “in-situ observation,” with an electrochemical scanning tunneling microscope (STM), of a formation mechanism in a reaction of forming, in a charging process, a coat on a surface of a graphite particle included in a negative electrode of a liquid-based lithium-ion secondary battery. It describes that in the liquid-based lithium-ion secondary battery, organic solvent molecules solvated with lithium ions are co-intercalated into a graphite crystal at a portion, such as a step, in which an edge of the graphite crystal is exposed, and the solvated lithium ions receive electrons between graphite layers at a negative electrode potential of around 0.8 V (vs. Li/Li⁺) and higher, so that the reductive decomposition occurs to form a solid electrolyte coat layer (hereinafter referred to as an SEI layer).

In a liquid-based lithium-ion secondary battery using a spheroidized natural graphite as the graphite particle, an electrolyte solution penetrates into voids present inside the spheroidized natural graphite in some cases. The spheroidized natural graphite is produced by spheroidizing a natural flake graphite that is the raw material by applying an external mechanical force thereto using a granulating machine such as a hybridization system. As a result, voids are likely to be formed between the folds of the natural flake graphite.

In a liquid-based lithium-ion secondary battery using an artificial graphite as the graphite particle, an electrolyte solution penetrates into the artificial graphite through open holes present on a surface of the artificial graphite in some cases. The artificial graphite is produced by repeating pitch impregnation and baking, and finally applying a graphitization treatment at 2700° C. to 3000° C. Therefore, a lot of open holes are likely to be formed on the surface of the artificial graphite in the process in which a hydrogen gas or a carbon dioxide gas generated during the carbonization of the pitch is released.

Inner surfaces of voids and/or open holes present inside the graphite particles have also a portion in which an edge of a graphite crystal is exposed. Thus, when the electrolyte solution penetrates into the voids and/or the open holes, a reductive decomposition reaction of the organic solvent contained in the electrolyte solution occurs not only on the surface of the graphite particle but also inside the graphite particle. This leads to a rapid increase in an irreversible capacity resulting from the reductive decomposition reaction and significant deterioration of the load characteristics due to formation of a highly resistant SEI layer. Therefore, for liquid-based lithium-ion secondary batteries, measures are taken such as adding an additive, such as vinylene carbonate, to the electrolyte solution, and coating the negative electrode active material with an amorphous carbon material that is poorly reactive to the reductive decomposition. In the case of a graphite particle, such as the spheroidized natural graphite or the artificial graphite, the electrolyte solution penetrates into the graphite particle, and thus the coating amount must be increased so as not to leave a non-coated portion in order to sufficiently achieve the effects of the coating with the carbon material. However, since the amorphous carbon material that is poorly reactive to the reductive decomposition has a specific capacity that is significantly lower than that of the graphite serving as the core material, there is a problem in that the specific capacity of the entire negative electrode active material including the coating layer decreases.

For example, JP 4045438 B describes that in the case where the graphite particle is a massive artificial graphite, pores associated with a specific surface area in accordance with a BET method are covered by using coal tar pitch as the starting material of a coating layer. Presumably, the massive artificial graphite serving as the core material disclosed here has a true density of as high as 2.25 g/cm³ and is highly graphitized, and the open holes formed in the process of graphitization are limitedly located on the outermost surface of the graphite particle. Therefore, in order to cover the open holes, a coating amount of 7.8 mass % or more is required. The graphitization process of the artificial graphite needs a heat treatment at 2800° C. to 3000° C., requiring significant amounts of fuel and electric power. Thus, in some cases, the graphitization is ended in a stage where a relatively good specific capacity of 320 mAh/g to 350 mAh/g can be obtained, that is, in a stage where a true density is approximately 2.0 g/cm³. In those cases, the open holes may be present not only on the surface of the particle but also inside the particle. It is inferred, including in such cases, that a coating amount of 15 mass % or more is required in order to suppress the reductive decomposition reaction of the organic solvent contained in the electrolyte solution and achieve high initial charge and discharge efficiency by completely filling the open holes extending from the surface of the artificial graphite particle into the artificial graphite particle.

For example, JP 6507395 B describes that in the case where the graphite particle is a spheroidized natural graphite, coal tar pitch is used as the starting material of a coating layer so as to produce a carbonaceous substance-coated graphite particle having a pore of 2 nm or less when measured with a BET adsorption method using a nitrogen gas. However, a coating amount of 15 to 30 mass % is required in order to suppress the reductive decomposition reaction of the organic solvent contained in the electrolyte solution and achieve high initial charge and discharge efficiency by decreasing the BET specific surface area of the coated particle.

For example, JP 3716818 B describes that a particle surface is coated by conducting a spheroidizing treatment using ethylenecellulose as a granulating agent, and then immersing the granulated natural graphite in coal tar pitch and heating it. However, it is inferred that a coating amount of 15 mass % or more is required in order to suppress the reductive decomposition reaction of the organic solvent contained in the electrolyte solution and achieve high initial charge and discharge efficiency by filling the voids present inside the particle in addition to coating the particle surface.

In contrast, in an all-solid-state lithium-ion secondary battery using a solid electrolyte such as a solid sulfide electrolyte, charge proceeds by allowing lithium ions alone to be intercalated into a graphite particle via an interface at which the solid electrolyte and the graphite particle are in contact with each other electrically. The present inventors found through their intensive studies that when charge proceeds and a negative electrode potential reaches around 0.2 V (vs. Li/Li⁺), electrons start to be imparted from a graphite particle to a solid sulfide electrolyte and the solid sulfide electrolyte undergoes reductive decomposition.

In a liquid-based lithium-ion secondary battery as shown in Carbon Journal of Carbon Research 2017, 3, 22, a reductive decomposition reaction of an electrolyte proceeds at a portion in which an edge of a graphite crystal on a surface of a graphite particle is exposed. In contrast, the verification by the present inventors reveals, as the results of transmission electron microscope (TEM) observation, etc. on the graphite negative electrode after a cycle test, that in all-solid-state lithium-ion secondary batteries, electrons are imparted from a graphite particle to a solid electrolyte at a portion as long as the solid electrolyte and the graphite particle are electrically connected to each other at that portion regardless of whether an edge of a graphite crystal is exposed at the portion, and a reductive decomposition reaction proceeds throughout the solid electrolyte. Since a solid electrolyte, such as a solid sulfide electrolyte, undergoes reductive decomposition at a potential lower than that of the organic solvent contained in the electrolyte solution, it can be said that the solid electrolyte has a reduction resistance higher than that of the electrolyte solution. However, in all-solid-state lithium-ion secondary batteries, the reductive decomposition reaction proceeds, throughout the solid electrolyte, at portions in which the graphite particle and the solid electrolyte are in contact with each other electrically, and thus there arises a concern that the irreversible capacity resulting from the reductive decomposition of the electrolyte increases compared to liquid-based lithium-ion secondary batteries.

As described above, liquid-based lithium-ion secondary batteries are different from all-solid-state lithium-ion secondary batteries in terms of the mechanism of the reductive decomposition reaction of the electrolyte. Therefore, in order to suppress the reductive decomposition reaction and reduce the irreversible capacity, measures specific to the all-solid-state lithium-ion secondary batteries are essential.

Thus, the present inventors arrived at the idea of forming more densely, on a surface of a negative electrode active material, “reaction active sites” at which lithium ions receive electrons from the negative electrode active material or a conductive additive and are intercalated into the negative electrode active material in an all-solid-state lithium-ion secondary battery. According to such a configuration, it is possible to increase the lithium ion receptivity of the negative electrode active material, and allow the electronic current flowing through the negative electrode to be spent on the reduction of lithium ions at a higher percentage than that spent on the reductive decomposition of the solid electrolyte. The present inventors thereby thought of reducing the irreversible capacity resulting from the reductive decomposition of the solid electrolyte.

Next, the “reaction active site” revealed through the studies by the present inventors will be described. Liquid-based lithium-ion secondary batteries are fundamentally different from all-solid-state lithium-ion secondary batteries in terms of the “reaction active site” at which lithium ions are intercalated into and de-intercalated from the negative electrode active material. The “reaction active site” affects the input/output performance of a battery.

When the present inventors started studying all-solid-state lithium-ion secondary batteries, a physical crack and a lattice defect, such as a portion in which carbon of a six membered ring is absent, a portion in which a six membered ring is entirely absent, and a gap between crystallites, on a surface of the carbonaceous substance of the negative electrode active material were supposed to be the “reaction active site.” In addition, an edge having a surface that is exposed at a step of a graphene layer, as shown in Carbon TANSO 2002 [No. 203] 136-140, was also supposed to be the “reaction active site.”

In liquid-based lithium-ion secondary batteries, lithium ions dissociated in the electrolyte solution are solvated with solvent molecules and carry the solvent molecules, and thus the lithium ions are present in the state of having a greater spatial breadth than when being alone. Therefore, steric hindrance due to the solvated solvent molecules are likely to occur at the time when the lithium ions are intercalated into the carbonaceous substance of the negative electrode active material. Specifically, it is difficult for the lithium ions to be intercalated from a narrow portion such as a portion in which carbon of a six membered ring is absent or a gap between crystallites. Therefore, in liquid-based lithium-ion secondary batteries, randomly-oriented graphene crystallites or an edge having a surface that is partially exposed at a step of a graphene layer, as shown in Carbon TANSO 2002 [No. 203] 136-140, is considered a major “reaction active site.”

In contrast, in all-solid-state lithium-ion secondary batteries, lithium ions are present alone and move inside a solid phase and through an interface, and thus steric hindrance seen in liquid-based lithium-ion secondary batteries does not occur. Also, as for all-solid-state lithium-ion secondary batteries, solid powder, in the particle size of several hundreds of nanometers to several tens of micrometers, that are composed of a solid electrolyte and a negative electrode active material are pressed at a high pressure of several ton forces per square centimeter to 10 ton forces per square centimeter so that the solid electrolyte and the negative electrode active material are electrically connected to each other. Therefore, it is hard to think that solid particles of the solid electrolyte are fit in depressions and projections on the order of several nanometers to several tens of nanometers, such as the randomly-oriented graphene crystallites or the step of a graphene layer, that are present on the surface of the carbon-coated layer of the negative electrode active material, in such a manner that gears are engaged with each other, and electrically connected to each other. The present inventors pressure-molded a solid powder composed of a solid electrolyte and a negative electrode active material at 6 tf/cm², obtained an electrode cross section by Cross Section Polisher (CP) (registered trademark) method, and observed the cross section with a field emission scanning electron microscope (FE-SEM). As a result, it was ascertained that almost flat portions, on the order of several hundreds of nanometers, of the solid electrolyte particles were in contact with each other in such a manner as to face each other rather than the solid electrolyte particles, on the order of several nanometers to several tens of nanometers, sticked together in such a manner as to follow minute depressions and projections on the surface of the carbon-coated layer. Even when the solid particles are in contact with each other in such a manner, all-solid-state lithium-ion secondary batteries perform charge and discharge operations normally. From the above results, the present inventors have reached a conclusion that in all-solid-state lithium-ion secondary batteries, a portion in which carbon of a six membered ring is absent or a gap between crystallites present on the carbon-coated layer surface that is almost flat on the order of several hundreds of nanometers is a major “reaction active site.”

Based on the above findings, the present inventors have arrived at the solid-state battery negative electrode of the present disclosure.

### (Overview of One Aspect According to the Present Disclosure)

A solid-state battery negative electrode according to a first aspect of the present disclosure includes
a negative electrode active material layer, the negative electrode active material layer including a solid electrolyte, and a coated active material having a negative electrode active material and a carbon material coating at least a part of a surface of the negative electrode active material, wherein
when a Raman spectrum of the coated active material is measured by Raman spectroscopy,
a ratio R_{D/G} of an integrated intensity of D band to an integrated intensity of G band is 1.5 or more.

According to the above configuration, it is possible to suppress an increase in reaction resistance at the time when lithium ions are intercalated and de-intercalated from the solid electrolyte into the negative electrode active material or from the negative electrode active material into the solid electrolyte in a potential region lower than 0.2 V (vs. Li/Li⁺), which is a negative electrode potential at which the reductive decomposition of the solid electrolyte starts. As a result, excellent load characteristics can be achieved, and short circuits at the time of high-rate charge can be suppressed. In addition, it is possible to suppress a reductive decomposition reaction of the solid electrolyte caused by the donation of electrons from the negative electrode active material to the solid electrolyte. As a result, the irreversible capacity can be reduced.

In a second aspect of the present disclosure, for example, in the solid-state battery negative electrode according to the first aspect, the ratio R_{D/G} may be 2.0 or more. According to such a configuration, it is possible to further reduce the irreversible capacity.

In a third aspect of the present disclosure, for example, in the solid-state battery negative electrode according to the first or second aspect, the ratio R_{D/G} may be 3.5 or less. According to such a configuration, it is possible to further reduce the irreversible capacity.

In a fourth aspect of the present disclosure, for example, in the solid-state battery negative electrode according to any one of the first to third aspects, a ratio of a mass of the carbon material to a mass of the coated active material may be less than 15%. According to such a configuration, it is possible to suppress a decrease in a reversible capacity due to an increase in the coating amount of the carbon material.

In a fifth aspect of the present disclosure, for example, in the solid-state battery negative electrode according to any one of the first to fourth aspects, the coated active material may have a BET specific surface area of more than 1.0 m²/g. According to such a configuration, it is possible to sufficiently secure a surface area in which particles of the solid electrolyte included in the negative electrode active material layer are electrically connected to particles of the coated active material, and thus the reaction resistance in the negative electrode active material layer can be reduced.

In a sixth aspect of the present disclosure, for example, in the solid-state battery negative electrode according to any one of the first to fifth aspects, the negative electrode active material may include a graphite. According to such a configuration, the negative electrode active material serving as the core material and the carbon material serving as the coating material are both carbon-based materials, making it possible to coat the core material with the carbon material more easily.

In a seventh aspect of the present disclosure, for example, in the solid-state battery negative electrode according to any one of the first to sixth aspects, a ratio of a volume of the coated active material to a volume of the negative electrode active material layer may be 50% or more and less than 70%. According to such a configuration, it is possible to suppress deterioration of charge rate performance.

In an eighth aspect of the present disclosure, for example, in the solid-state battery negative electrode according to any one of the first to seventh aspects, the solid electrolyte may include a solid sulfide electrolyte. According to such a configuration, it is possible to reduce the irreversible capacity resulting from the reductive decomposition of the solid electrolyte, and also achieve a solid-state battery having excellent load characteristics.

In a ninth aspect of the present disclosure, for example, in the solid-state battery negative electrode according to the eighth aspect, the solid sulfide electrolyte may include at least one selected from the group consisting of a Li₂S—P₂S₅-based glass-ceramic electrolyte and a solid argyrodite-type sulfide electrolyte. According to such a configuration, it is possible to achieve a solid-state battery with further enhanced charge and discharge characteristics. Moreover, the irreversible capacity resulting from the reductive decomposition of the solid electrolyte can be further reduced.

A solid-state battery according to a tenth aspect of the present disclosure includes:
a positive electrode;
a negative electrode; and
a solid electrolyte layer disposed between the positive electrode and the negative electrode, wherein
the negative electrode is the solid-state battery negative electrode according to any one of the first to ninth aspects.

According to the above configuration, it is possible to reduce the irreversible capacity resulting from the reductive decomposition of the solid electrolyte, and also achieve excellent load characteristics.

Embodiments of the present disclosure will be described below with reference to the drawings.

### Embodiment 1

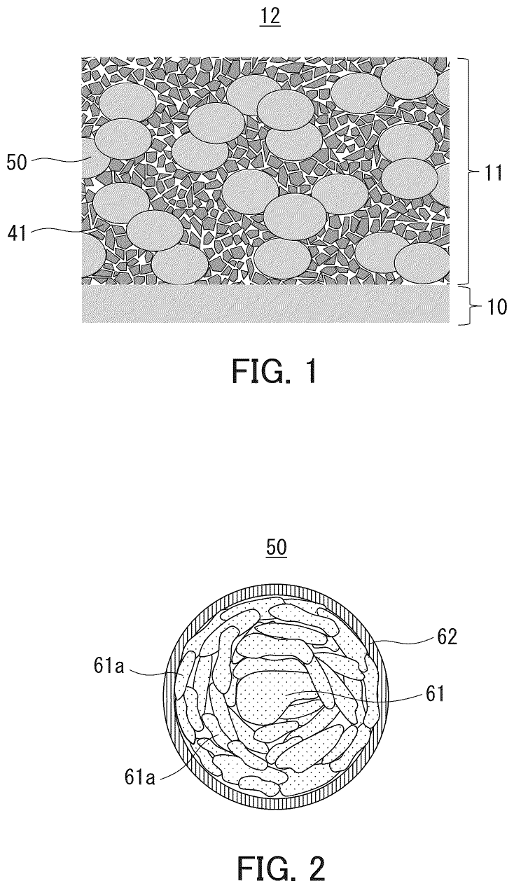

FIG. 1 is a cross-sectional view schematically showing the configuration of an all-solid-state lithium-ion secondary battery negative electrode of Embodiment 1.

### [All-Solid-State Lithium-Ion Secondary Battery Negative Electrode]

A negative electrode 12 for an all-solid-state lithium-ion secondary battery 100 of Embodiment 1 includes a negative electrode current collector 10 and a negative electrode active material layer 11. The negative electrode active material layer 11 is in contact with the negative electrode current collector 10. The negative electrode active material layer 11 includes a solid electrolyte 41 and a coated active material 50. The coated active material 50 has a negative electrode active material 61, and a carbon material 62 coating at least a part of a surface of the negative electrode active material 61. Particles of the solid electrolyte 41 and particles of the coated active material 50 are mixed and compressed to form the negative electrode active material layer 11.

### [Negative Electrode Current Collector]

The negative electrode current collector 10 is formed of a conductive material. Examples of the conductive material include a metal, a conductive oxide, a conductive nitride, a conductive carbide, a conductive boride, and a conductive resin.

### [Negative Electrode Active Material Layer]

The negative electrode active material layer 11 is a layer in which the coated active material 50 and the solid electrolyte 41 are mixed in a predetermined volume composition ratio and dispersed. The negative electrode active material layer 11 has both an electron conduction path formed by contact between the particles of the coated active material 50 and an ion conduction path formed by connection between the particles of the solid electrolyte 41.

A ratio of a volume of the coated active material 50 to a volume of the negative electrode active material layer 11 may be, in percentage, 50% or more and less than 70%. In the case where the ratio is 50% or more and less than 70%, it is possible to suppress deterioration of charge rate performance of the all-solid-state lithium-ion secondary battery. In the case where only the solid electrolyte 41 and the coated active material 50 are included in the negative electrode active material layer 11, the above ratio is the ratio of the volume of the coated active material 50 to the sum of the volume of the solid electrolyte 41 and the volume of the coated active material 50.

The negative electrode active material layer 11 may include a conductive additive, a binder, and the like as necessary.

The material of the conductive additive is not particularly limited as long as it has electron conductivity. Examples of the conductive additive include a carbon material, a metal, and a conductive polymer. Examples of the carbon material include a graphite, such as a natural graphite or an artificial graphite, acetylene black, carbon black, Ketjenblack, a carbon whisker, needle coke, and a carbon fiber. Examples of the natural graphite include a massive graphite and a flake graphite. Examples of the metal include copper, nickel, aluminum, silver, and gold. These materials may be used alone or in combination as a mixture of two or more thereof. The conductive additive contributes to reducing the resistance of the negative electrode active material layer 11 to electrons.

The material of the binder is not particularly limited as long as it serves the role of binding particles of the active material and particles of the conductive additive. Examples of the binder include a fluorine-including resin, such as polytetrafluoroethylene (PTFE), polyvinylidene fluoride (PVdF), and a fluorine rubber, a thermoplastic resin, such as polypropylene or polyethylene, ethylene propylene diene monomer (EPDM) rubber, sulfonated EPDM rubber, and natural butyl rubber (NBR). These materials may be used alone or in combination as a mixture of two or more thereof. The binder may be, for example, an aqueous dispersion of a cellulosic material or styrene-butadiene rubber (SBR). The binder exhibits an effect of maintaining the shape of the negative electrode active material layer 11.

Examples of the solvent in which the coated active material 50, the solid electrolyte 41, the conductive agent, and the binder are dispersed include N-methylpyrrolidone, dimethylformamide, dimethylacetamide, methyl ethyl ketone, cyclohexanone, methyl acetate, methyl acrylate, diethylenetriamine, N,N-dimethylaminopropylamine, ethylene oxide, and tetrahydrofuran. For example, a dispersant and/or a thickener may be further added to the solvent. Examples of the thickener include carboxymethyl cellulose (CMC) and methyl cellulose.

The negative electrode active material layer 11 may have a thickness of 5 μm or more and 200 μm or less. In widely and generally used wet coating processes, for example, with an applicator or by die coating, the lower limit for thickness control on the coating film is 10 μm. From this point, the lower limit for film thickness after drying is generally suggested to be 5 μm, depending on the proportion of the solid component in the coating slurry. By appropriately adjusting the thickness of the negative electrode active material layer 11, it is possible to prevent electrode breakage during the drying, thereby enhancing the yield. In the case where a high-capacity material, such as silicon, is used as the core material of the coated active material 50 (that is, the negative electrode active material 61), the thickness of the negative electrode active material layer 11 can be reduced to 10 μm or less.

### (Coated Active Material)

FIG. 2 is a cross-sectional view schematically showing the configuration of the coated active material 50. The coated active material 50 has the negative electrode active material 61, and the carbon material 62 coating at least a part of the surface of the negative electrode active material 61. The negative electrode active material 61 is a material having properties of occluding and releasing lithium ions.

When a Raman spectrum of the coated active material 50 is measured by Raman spectroscopy using a laser beam with an excitation wavelength of 532 nm, a ratio R_{D/G} of an integrated intensity of D band to an integrated intensity of G band is 1.5 or more. In the present disclosure, D band refers to a molecular vibration mode of a graphite crystal that appears, due to absence of carbon in a six membered ring, at around 1360 cm⁻¹ in a Raman spectrum obtained by Raman spectroscopy. G band refers to a molecular vibration mode of an ideal graphite crystal without the absence of carbon or the like appearing at around 1580 cm⁻¹ in the above-mentioned Raman spectrum. The method for measuring the ratio R_{D/G} will be described later.

When the ratio R_{D/G} is 1.5 or more, it is possible to suppress an increase in reaction resistance at the time when lithium ions are intercalated and de-intercalated from the solid electrolyte 41 into the negative electrode active material 61 or from the negative electrode active material 61 into the solid electrolyte 41 in a potential region lower than 0.2 V (vs. Li/Li⁺), which is a negative electrode potential at which the reductive decomposition of the solid electrolyte 41 starts. As a result, excellent load characteristics can be achieved, and short circuits at the time of high-rate charge can be suppressed. In addition, it is possible to suppress a reductive decomposition reaction of the solid electrolyte 41 caused by the donation of electrons from the negative electrode active material 61 to the solid electrolyte 41. As a result, the irreversible capacity can be reduced.

The ratio R_{D/G} may be 2.0 or more. According to the above configuration, it is possible to further reduce the irreversible capacity.

The ratio R_{D/G} may be 3.5 or less. That is, the ratio R_{D/G} may be 1.5 or more and 3.5 or less, or 2.0 or more and 3.5 or less. According to the above configuration, it is possible to further reduce the irreversible capacity.

The ratio R_{D/G} may be 3.1 or less. That is, the ratio R_{D/G} may be 1.5 or more and 3.1 or less, or 2.0 or more and 3.1 or less.

A ratio of a mass of the carbon material 62 to a mass of the coated active material 50 may be, in percentage, less than 15%.

For example, in the case of coating a negative electrode active material with a carbon material by a method using a conventional material, such as tar or pitch, as a carbonaceous substance precursor, the obtained carbon material tends to have a low degree of graphitization and has a specific capacity lower than that of a graphite. However, when the ratio of the mass of the carbon material 62 to the mass of the coated active material 50 is less than 15%, the mass ratio of the carbon material 62 having a lower specific capacity decreases and the specific capacity of the effectual coated active material 50 increases. This makes it possible to suppress a decrease in the reversible capacity due to an increase in the coating amount of the carbon material 62. The method for measuring the ratio of the mass of the carbon material 62 to the mass of the coated active material 50 will be described later.

The ratio of the mass of the carbon material 62 to the mass of the coated active material 50 may be 1% or more and less than 15%. When the ratio is 1% or more, the thickness of the carbon material 62 is not too small. If the thickness of the carbon material 62 is too small, the carbon material 62 comes off by friction against the solid electrolyte 41 under pressure molding, and thus the negative electrode active material 61 is exposed. Also, the solid electrolyte 41 breaks the carbon material 62 and comes into direct contact with the negative electrode active material 61. When the above-mentioned ratio is 1% or more, the surface of the negative electrode active material 61 can be sufficiently coated with the carbon material 62, making it possible to improve the load characteristics and obtain a sufficient effect of suppressing the reductive decomposition reaction.

The coated active material 50 may have a BET specific surface area of more than 1.0 m²/g.

In all-solid-state lithium-ion secondary batteries during the charge operation, electrons are imparted from the coated active material 50 to lithium ions by a reduction reaction and lithium is taken into the coated active material 50. Here, if the BET specific surface area of the coated active material 50 is too small, electrons fail to be sufficiently imparted and the load characteristics are deteriorated. When the BET specific surface area of the coated active material 50 is more than 1.0 m²/g, it is possible to sufficiently secure a surface area in which the particles of the solid electrolyte 41 are electrically connected to the particles of the coated active material 50. As a result, the reaction resistance in the negative electrode active material layer 11 can be reduced. The method for measuring the BET specific surface area of the coated active material 50 will be described later.

The coated active material 50 may have a BET specific surface area of more than 1.0 m²/g and 15 m²/g or less.

If the BET specific surface area of the coated active material 50 is too large, minute depressions and projections on a surface of the coated active material 50 become rougher, making it difficult to secure electrical contact between the solid electrolyte 41 and the coated active material 50. In addition, the coated active material 50 becomes bulky, requiring a large storage place. Furthermore, the viscosity of an electrode slurry rises remarkably, making it impossible to apply it onto a current collecting foil.

When the Raman spectrum of the coated active material 50 is measured by Raman spectroscopy using a laser beam with an excitation wavelength of 532 nm, a full width half maximum value Δv_{G} of the peak in G band may be smaller than 30 cm⁻¹.

According to the above configuration, it is possible to reduce the mass ratio of the carbon material 62 without diminishing the effect of reducing the reaction resistance brought by coating the negative electrode active material 61 with the carbon material 62 and the effect of reducing the irreversible capacity brought by the reductive decomposition of the solid electrolyte. This makes it possible to suppress a decrease in the reversible capacity due to an increase in the coating amount of the carbon material 62. The method for measuring the full width half maximum value Δv_{G} of the peak in G band of the coated active material 50 will be described later.

Examples of the material of the negative electrode active material 61 include a metal, a metalloid, an oxide, a nitride, and a carbon. Examples of the metal or the metalloid include lithium, silicon, amorphous silicon, aluminum, silver, tin, antimony, and an alloy thereof. Examples of the oxide include Li₄Ti₅O₁₂, Li₂SrTi₆O₁₄, TiO₂, Nb₂O₅, SnO₂, Ta₂O₅, WO₂, WO₃, Fe₂O₃, CoO, MoO₂, SiO, SnBPO₆, and a mixture thereof. Examples of the nitride include LiCON, Li₃FeN₂, Li₇MnN₄, and a mixture thereof. Examples of the carbon include a spheroidized natural graphite obtained by folding a natural flake graphite into a spherical shape for spheroidizing with a hybridization device, mesocarbon microbead (hereinafter referred to as MCMB), a spherocrystal graphite, an artificial graphite obtained by using coal coke or petroleum coke as the raw material, hard carbon, soft carbon, a carbon nanotube, and a mixture thereof. As the negative electrode active material 61, these negative electrode active materials can be used alone or in combination of two or more thereof.

The negative electrode active material 61 may include a graphite, such as a spheroidized natural graphite or an artificial graphite.

A graphite, such as a spheroidized natural graphite or an artificial graphite, is easily controlled in terms of mechanical properties, such as shape and hardness.

Therefore, according to the above configuration, the core material can be coated with the carbon material more easily because the negative electrode active material 61 serving as the core material and the carbon material 62 serving as the coating material are both carbon-based materials.

The negative electrode active material 61 may be a graphite.

The negative electrode active material 61 may be a spheroidized natural graphite obtained by folding a natural flake graphite into a spherical shape for spheroidizing. In the example of FIG. 2, the negative electrode active material 61 is a spheroidized natural graphite obtained by folding a natural flake graphite 61a into a spherical shape for spheroidizing.

The shape of the negative electrode active material 61 is not particularly limited, and may be acicular, spherical, ellipsoidal, flaky, or the like. The negative electrode active material 61 may be particulate.

As the carbon material 62, those mentioned as the material of the negative electrode active material 61 can be used.

The coated active material 50 may have a median diameter of 5 μm or more and 20 μm or less. In the case where the coated active material 50 has a median diameter within such a range, it is possible to sufficiently reduce the thickness of the negative electrode active material layer 11.

In the present disclosure, the “median diameter” means the particle diameter at a cumulative volume equal to 50% in the volumetric particle size distribution. The volumetric particle size distribution is measured, for example, with a laser diffraction analyzer.

### (Solid Electrolyte)

As the solid electrolyte 41, a solid inorganic electrolyte, a solid polymer electrolyte, or a mixture thereof can be used. The solid inorganic electrolyte includes a solid sulfide electrolyte and a solid oxide electrolyte.

The solid electrolyte 41 may include a solid sulfide electrolyte. According to the above configuration, the irreversible capacity resulting from the reductive decomposition of the solid electrolyte 41 is suppressed, making it possible to achieve a solid-state battery having excellent load characteristics.

The solid sulfide electrolyte, which may be included in the solid electrolyte 41, may include a Li₂S—P₂S₅-based glass-ceramic electrolyte. The Li₂S—P₂S₅-based glass-ceramic electrolyte is a solid sulfide electrolyte in the form of glass-ceramics. Examples of the Li₂S—P₂S₅-based glass-ceramic electrolyte include Li₂S—P₂S₅, Li₂S—P₂S₅—LiI, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—GeS, Li₂S—P₂S₅—ZnS, Li₂S—P₂S₅—GaS, Li₂S—GeS₂, Li₂S—SiS₂—Li₃PO₄, Li₂S—SiS₂—LiPO, Li₂S—SiS₂—LiSiO, Li₂S—SiS₂—LiGeO, Li₂S—SiS₂—LiBO, Li₂S—SiS₂—LiAlO, Li₂S—SiS₂—LiGaO, Li₂S—SiS₂—LiInO, Li₄GeS₄—Li₃PS₃, Li₄SiS₄—Li₃PS₄, and Li₃PS₄—Li₂S. According to the above configuration, it is possible to achieve a solid-state battery with further enhanced charge and discharge characteristics.

The solid sulfide electrolyte, which may be included in the solid electrolyte 41, may include a solid argyrodite-type sulfide electrolyte. The solid argyrodite-type sulfide electrolyte is a solid sulfide electrolyte having an argyrodite-type crystal phase with high ion conductivity. An example of the solid argyrodite-type sulfide electrolyte is Li₆PS₅Cl. According to the above configuration, it is possible to further reduce the irreversible capacity resulting from the reductive decomposition of the solid electrolyte 41.

The solid electrolyte 41 may include only the solid sulfide electrolyte. In other words, the solid electrolyte 41 may consist substantially of the solid sulfide electrolyte. In the present disclosure, the term “including only a solid sulfide electrolyte” means that materials other than the solid sulfide electrolyte are not intentionally added except for inevitable impurities. For example, raw materials of the solid sulfide electrolyte, by-products generated in the production of the solid sulfide electrolyte, and the like are included in the inevitable impurities.

Examples of the solid oxide electrolyte, which may be included in the solid electrolyte 41, include LiPON, LiAlTi(PO₄)₃, LiAlGeTi(PO₄)₃, LiLaTiO, LiLaZrO, Li₃PO₄, Li₂SiO₂, Li₃SiO₄, Li₃VO₄, Li₄SiO₄—Zn₂SiO₄, Li₄GeO₄—Li₂GeZnO₄, Li₂GeZnO₄—Zn₂GeO₄, and Li₄GeO₄—Li₃VO₄.

Examples of the solid polymer electrolyte, which may be included in the solid electrolyte 41, include a fluororesin, polyethylene oxide, polyacrylonitrile, polyacrylate, a derivative thereof, and a copolymer thereof.

The shape of the solid electrolyte 41 is not particularly limited, and may be acicular, spherical, ellipsoidal, flaky, or the like. The shape of the solid electrolyte 41 may be particulate.

In the case where the shape of the solid electrolyte 41 is particulate (e.g., spherical), the solid electrolyte 41 may have a median diameter smaller than that of the coated active material 50. In this case, the coated active material 50 and the solid electrolyte 41 can form a more favorable dispersion state in the negative electrode active material layer 11.

The median diameter of the solid electrolyte 41 may be set so as to correspond to the median diameter of the coated active material 50. In the case where the coated active material 50 has a median diameter of 5 μm or more and 20 μm or less, the solid electrolyte 41 may have a median diameter of 0.5 μm or more and 2 μm or less. According to the above configuration, it is possible to obtain a negative electrode mixture in which the coated active material 50 and the solid electrolyte 41 are electrically connected to each other in a satisfactory manner by pressure-molding.

<Method for Manufacturing all-Solid-State Lithium-Ion Secondary Battery Negative Electrode>

Next, the method for manufacturing the negative electrode 12 for the all-solid-state lithium-ion secondary battery 100 will be described. The negative electrode 12 for the all-solid-state lithium-ion secondary battery 100 can be produced in the following manner, for example.

First, the method for producing the coated active material 50 will be described. The coated active material 50 can be produced in the following manner, for example.

The negative electrode active material 61 is prepared. The negative electrode active material 61 may be a spheroidized natural graphite obtained by folding a natural flake graphite into a spherical shape for spheroidizing.

At least a part of the surface of the negative electrode active material 61 is coated with the carbon material 62, and the coated active material 50 can thereby be obtained. For example, it is possible to coat, with the carbon material 62, at least a part of the surface of the negative electrode active material 61 by using a chemical vapor deposition method (CVD method). In the CVD method, while a kiln filled with the negative electrode active material 61 is being rotated, a gas to be a carbon source may be introduced thereinto and the negative electrode active material 61 may be heated. As the gas to be a carbon source, a gas obtained by mixing a hydrocarbon gas, such as ethylene or propane, and an inert gas, such as nitrogen or argon, may be used. Using such a gas mixture as the raw material, the negative electrode active material 61 may be coated by the CVD method while stirring the negative electrode active material 61 in a rotational flow reactor at a temperature of 700° C. to 1200° C.

For example, the above-mentioned rotational flow CVD method makes it easy to adjust the ratio R_{D/G}. Accordingly, the coated active material 50 satisfying a ratio R_{D/G} of 1.5 or more can be produced relatively easily.

The obtained coated active material 50 and the solid electrolyte 41 are mixed to prepare a negative electrode mixture. The negative electrode mixture is pressure-molded to obtain the negative electrode active material layer 11. The negative electrode mixture may include a conductive additive, a binder, and the like as necessary. Also, a thickener, such as ethylenecellulose, may be added to the negative electrode mixture to adjust the viscosity of the electrode slurry. The negative electrode current collector 10 is disposed on one surface of the negative electrode active material layer 11 and pressed to produce the negative electrode 12.

### <Methods for Measuring Physical Properties>

Next, the methods for measuring physical properties of the coated active material 50 will be described.

### <Method for Measuring Ratio R_{D/G} and Full Width Half Maximum Value Av by Raman Spectroscopy>

For measuring a Raman spectrum by Raman spectroscopy, a laser Raman microscope (RAMANtouch manufactured by Nanophoton Corporation) can be used.

The measurement conditions are as follows.
Measuring mode: Point measuring mode
Object lens: TU Plan Fluor, 10 power
Exposure time: 300 seconds
Number of integration events: 3 events
Excitation wavelength: 532 nm
Laser power: 0.8 to 1.0 mW (adjusted by an ND (Neutral Density) filter)
Center wavelength: 1450 cm⁻¹.
Diffraction grating: 600 gr/mm

A proper amount of powder of the coated active material 50 is put in a recess that is a square of 10 mm×10 mm with a depth of 0.2 mm provided on a glass plate, the surface thereof is leveled, and a Raman spectrum measurement is made at a plurality of places (nine places in total, for example) vertically and horizontally in the square of 10 mm×10 mm, in which several points (three points, for example) are measured at each of the places.

Using a data analysis software (Origin manufactured by OriginLab Corporation), the obtained Raman spectrum is subjected to peak fitting by using a Lorentz function as a peak shape function.

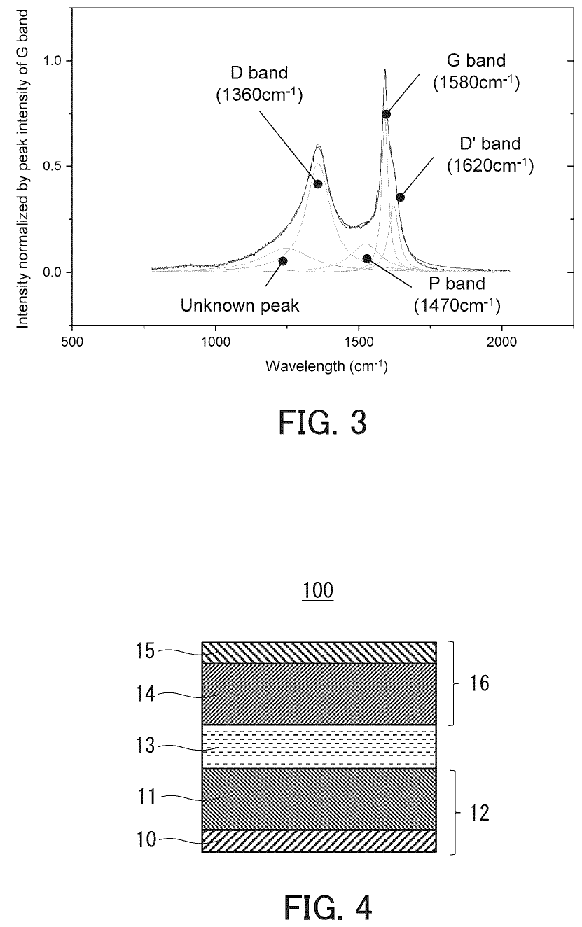

FIG. 3 is a graph showing a Raman spectrum of a spheroidized natural graphite coated using petroleum pitch as a carbonaceous substance precursor, and an example of peak fitting thereof.

As shown in Carbon TANSO 1996 [No. 175] 304-313, various types of polycyclic aromatic compounds are included in petroleum pitch. As shown in FIG. 3, the Raman spectrum shows P band derived from five-membered aromatic series at around 1470 cm⁻¹, in addition to D band at around 1360 cm⁻¹ and D′ band at around 1620 cm⁻¹. It also shows a peak at around 1210 cm⁻¹ and a peak at around 1530 cm⁻¹ that are unknown from what they are derived. When discussing the sparseness and density of the gaps between crystallites that the present inventors are focusing on, it is important not only to separate these peaks clearly by data analysis but also to use an integrated intensity ratio, instead of a peak intensity ratio, as the physical property index value pf the coating carbonaceous substance.

The domain of integration is from 800 cm⁻¹ to 2100 cm⁻¹. The integrated intensity of D band at around 1360 cm⁻¹ is defined as 11360, and the integrated intensity of G band at around 1580 cm⁻¹ is defined as 11580. Here, the ratio R_{D/G} is calculated as I₁₃₆₀/I₁₅₈₀. The full width half maximum value Δv_{G} is calculated by separating the peak at around 1530 cm⁻¹ adjacent to G band and the peak of D′ band at around 1620 cm⁻¹.

The average value of the ratios R_{D/G} and the average value of full width half maximum values Δv_{G} calculated from the Raman spectrums at a plurality of places (nine places in total, for example) are defined as the ratio R_{D/G} and the full width half maximum value Δv_{G} of the coated active material 50.

### <Method for Measuring BET Specific Surface Area>

The BET specific surface area of the coated active material 50 can be calculated, by a BET method, from an adsorption isotherm obtained by a gas absorption method, using a specific surface area/pore distribution measuring device (BELSORP-MINI manufactured by MicrotracBEL Corp.). Taking into consideration the possibility for micropores (<2 nm) to be included in the carbon material 62, it is recommended that, in accordance with an IUPAC report in 2015 (Pure and Applied Chemistry 87, 1051 (2015)), 87K argon be used as an adsorption gas instead of 77K nitrogen since argon molecules are smaller than nitrogen molecules and also enter into the micropores easily.

### <Method for Measuring Geometric Specific Surface Area>

In all-solid-state lithium-ion secondary batteries, a geometric specific surface area estimated from the general shape of micrometer-scale particles measured by a gas absorption method is also an important physical property in addition to a BET specific surface area including even open holes that are 2 nm or less in size and pores inside the particles. For the geometric specific surface area, nanometer-scale minute depressions and projections on a surface and pores inside the particles are ignored. Information as to the particle shape, such as the area equivalent diameter and sphericity of the particles of the coated active material 50, can be obtained by, for example, particle shape analysis with a particle shape analyzer manufactured by Malvern Panalytical Ltd. The fine particles of the coated active material 50 having an area equivalent diameter of less than 0.5 μm have a particle diameter less than the lower limit particle diameter at which the shape is recognizable, and are accordingly excluded from the analysis data of the geometric specific surface area. The average area equivalent diameter is calculated from a two-dimensional image of 20000 to 30000 particles of the coated active material 50 having an area equivalent diameter of 0.5 μm or more, and a sphere equivalent surface area Sₛₚₕₑᵣₑ and a sphere equivalent volume Vₛₚₕₑᵣₑ are calculated by assuming a perfect sphere. The sphere equivalent volume Vₛₚₕₑᵣₑ is multiplied by the true density of the coated active material 50 to calculate a sphere equivalent weight Wₛₚₕₑᵣₑ. The sphere equivalent surface area Sₛₚₕₑᵣₑ is divided by the sphere equivalent weight Wₛₚₕₑᵣₑ to define the geometric specific surface area.

### <Method for Measuring Ratio of Mass of Carbon Material to Mass of Coated Active Material>

The ratio of the mass of the carbon material 62 to the mass of the coated active material 50 can be calculated from the amounts of the materials used. Specifically, it is possible to measure the mass of the carbon material 62 by measuring, with a precision electronic balance, the increase in the mass of the negative electrode active material 61, which is the core powder of the coated active material 50, between before and after the negative electrode active material 61 is coated with the carbon material 62.

It is also possible to calculate the ratio of the mass of the carbon material 62 to the mass of the coated active material 50 by measuring the Raman spectrum of the coated active material 50 by Raman spectroscopy. When the excitation wavelength of Raman spectroscopy is increased and the light reaches the negative electrode active material 61 serving as the core material, a Raman spectrum of the negative electrode active material 61 appears. Here, in the Raman spectrum, D band at around 1360 cm⁻¹ due to disorder of the graphite structure disappears and G band at around 1580 cm⁻¹ remains. The absorbance of the carbon material 62 can be determined from the excitation wavelength at that time. The penetration depth can be calculated from the determined absorbance, and the thickness of the carbon material 62 can be estimated from the penetration depth. Based on the estimated thickness, the carbon material 62 present on the surface of the coated active material 50 is scraped and the decrease in the mass of the coated active material 50 between before and after the scraping is measured with a precision electronic balance, and the mass of the carbon material 62 can thereby be measured.

It is also possible to calculate the ratio of the mass of the carbon material 62 to the mass of the coated active material 50 by observing a cross section with a scanning electron microscope (SEM). First, powder of the coated active material 50 is pressed against a piece of carbon having a cut made with a cutter, and the pressed surface is subjected to a Cross Section Polisher (CP) (registered trademark) process. This method makes it possible to obtain a cross section of the coated active material 50 without damaging the physical shape of the coated active material 50. Next, the cross section is observed using an SEM. The carbon material 62 has crystallinity lower than that of the negative electrode active material 61, and includes a certain amount of elements with different atomic numbers, such as hydrogen and nitrogen contained in a reactive gas or an atmospheric gas. By observing a backscattered electron image in which the differences between atomic numbers appear as contrast, it is possible to distinguish the carbon material 62 from the negative electrode active material 61 relatively easily. Based on the differences as contrast in the backscattered electron image, the thickness of the carbon material 62 can be measured. Based on the measured thickness, the coating layer of the carbon material 62 present on the surface of the coated active material 50 is scraped. The decrease in the mass of the coated active material 50 between before and after the scraping is measured with a precision electronic balance, and the mass of the carbon material 62 can thereby be measured.

In the case where the coated active material 50 is included in the negative electrode active material layer 11, the coated active material 50 can be taken out by the following method, for example. The negative electrode active material layer 11 is dispersed in a solvent that dissolves the solid electrolyte 41. The solvent in which the solid electrolyte 41 is dissolved is separated from the rest. The rest is dried, and the coated active material 50 can thereby be taken out.

### <Method for Measuring Median Diameter>

The median diameter of the coated active material 50 can be measured using a laser diffraction particle size distribution analyzer (manufactured by HORIBA, Ltd.).

### <Method for Measuring Aspect Ratio>

An aspect ratio of the coated active material 50 is determined as the ratio of the short-axis diameter to the long-axis diameter of the coated active material 50. The aspect ratios of a plurality (from 100 to 200, for example) of the coated active materials 50 are determined and the average value thereof can be defined as the aspect ratio of the coated active material 50.

In the case where the coated active material 50 is included in the negative electrode active material layer 11, the contour of the coated active material 50 can be obtained by, for example, particle shape analysis with the particle shape analyzer manufactured by Malvern Panalytical Ltd. explained in the method for measuring the geometric specific surface area described above. The contour of the coated active material 50 can also be extracted by the following method. The negative electrode active material layer 11 is subjected to a cross-section process by Cross Section Polisher (CP) (registered trademark) method, and the polished surface is observed with a field emission scanning electron microscope (FE-SEM). The contour of the coated active material 50 can be extracted from the captured FE-SEM image.

### Embodiment 2

Embodiment 2 will be described below. The description overlapping with that of Embodiment 1 will be omitted as appropriate.

FIG. 4 is a cross-sectional view schematically showing the configuration of an all-solid-state lithium-ion secondary battery 100 of Embodiment 2.

The all-solid-state lithium-ion secondary battery 100 can be configured as batteries having various shapes, such as a coin type, a cylindrical type, a prismatic type, a sheet type, a button type, a flat type, or a stacked type.

The all-solid-state lithium-ion secondary battery 100 of Embodiment 2 includes a positive electrode 16, a solid electrolyte layer 13, and a negative electrode 12. The solid electrolyte layer 13 is disposed between the positive electrode 16 and the negative electrode 12.

The negative electrode 12 is for the all-solid-state lithium-ion secondary battery 100 of Embodiment 1. According to the above configuration, it is possible to reduce the irreversible capacity resulting from the reductive decomposition of the solid electrolyte 41 and achieve excellent load characteristics in the all-solid-state lithium-ion secondary battery 100.

### [Positive Electrode]

The positive electrode 16 includes a positive electrode current collector 15 and a positive electrode active material layer 14. The positive electrode active material layer 14 includes a solid electrolyte and a positive electrode active material.

### [Positive Electrode Current Collector]

The positive electrode current collector 15 is formed of an electronic conductor. As the material of the positive electrode current collector 15, those described for the negative electrode current collector 10 of Embodiment 1 can be used as appropriate.

### [Positive Electrode Active Material Layer]

The positive electrode active material layer 14 is a layer in which the positive electrode active material and the solid electrolyte are mixed in a predetermined volume composition ratio and dispersed.

A ratio of a volume of the positive electrode active material to a volume of the positive electrode active material layer 14 may be 60% or more and 90% or less.

The positive electrode active material layer 14 may include a conductive additive, a binder, and the like as necessary. As the conductive additive and the binder, those described for the negative electrode active material layer 11 of Embodiment 1 can be used as appropriate.

The positive electrode active material layer 14 may have a thickness of 5 μm or more and 200 μm or less for the same reason as in the case of the negative electrode active material layer 11.

### (Positive Electrode Active Material)

The positive electrode active material is a material having properties of occluding and releasing lithium ions.

Examples of the material of the positive electrode active material include a lithium-including transition metal oxide, a vanadium oxide, a chromium oxide, and a lithium-including transition metal sulfide. Examples of the lithium-including transition metal oxide include LiCoO₂, LiNiO₂, LiMnO₂, LiMn₂O₄, LiNiCoMnO₂, LiNiCoO₂, LiCoMnO₂, LiNiMnO₂, LiNiCoMnO₄, LiMnNiO₄, LiMnCoO₄, LiNiCoAIO₂, LiNiPO₄, LiCoPO₄, LiMnPO₄, LiFePO₄, Li₂NiSiO₄, Li₂CoSiO₄, Li₂MnSiO₄, Li₂FeSiO₄, LiNiBO₃, LiCoBO₃, LiMnBO₃, and LiFeBO₃. Examples of the lithium-including transition metal sulfide include LiTiS₂, Li₂TiS₃, and Li₃NbS₄. As the positive electrode active material, these positive electrode active materials can be used alone or in combination of two or more thereof.

The positive electrode active material layer 14 may include, as the positive electrode active material, Li(Ni, Co, Mn)O₂.

In the present disclosure, when an element in a formula is expressed by “(Ni, Co, Mn)” or the like, this expression indicates at least one element selected from the group of elements in parentheses. That is, “(Ni, Co, Mn)” is synonymous with “at least one selected from the group consisting of Ni, Co, and Mn”. The same applies to other elements.

The positive electrode active material layer 14 may include, as the positive electrode active material, Li(NiCoMn)O₂ (hereinafter referred to as NCM). The positive electrode active material layer 14 may include, as the positive electrode active material, NCM in which Ni:Co:Mn=5:2:3. NCM in which Ni:Co:Mn=5:2:3 is hereinafter referred to as NCM523.

The positive electrode active material may have a median diameter of 1 μm or more and 10 μm or less. In the case where the positive electrode active material is in the form of secondary particles obtained by granulating primary particles having the size of approximately 0.1 μm to 1 μm through sintering and aggregation, the upper limit for median diameter of the positive electrode active material maybe 10 μm.

### (Solid Electrolyte)

As the solid electrolyte included in the positive electrode active material layer 14, a solid inorganic electrolyte or a solid polymer electrolyte can be used. As the solid inorganic electrolyte and the solid polymer electrolyte, those described for the negative electrode active material layer 11 of Embodiment 1 can be used as appropriate.

The positive electrode active material layer 14 may include, as the solid electrolyte, a solid sulfide electrolyte. As the solid sulfide electrolyte, those described for the negative electrode active material layer 11 of Embodiment 1 can be used as appropriate.

The shape of the solid electrolyte included in the positive electrode active material layer 14 is not particularly limited, and may be acicular, spherical, ellipsoidal, flaky, or the like. The shape of the solid electrolyte included in the positive electrode active material layer 14 may be particulate.

In the case where the shape of the solid electrolyte included in the positive electrode active material layer 14 is particulate (e.g., spherical), the solid electrolyte included in the positive electrode active material layer 14 may have a median diameter smaller than that of the positive electrode active material. In this case, the positive electrode active material and the solid electrolyte can form a more favorable dispersion state in the positive electrode active material layer 14.

The median diameter of the solid electrolyte included in the positive electrode active material layer 14 may be set so as to correspond to the median diameter of the positive electrode active material. In the case where the positive electrode active material has a median diameter of 1 μm or more and 10 μm or less, the solid electrolyte included in the positive electrode active material layer 14 may have a median diameter of 0.1 μm or more and 1 μm or less. According to the above configuration, it is possible to lower the porosity of the positive electrode active material layer 14.

### [Solid Electrolyte Layer]

The solid electrolyte layer 13 is a layer including a solid electrolyte. As the solid electrolyte included in the solid electrolyte layer 13, a solid inorganic electrolyte or a solid polymer electrolyte can be used. As the solid inorganic electrolyte and the solid polymer electrolyte, those described for the negative electrode active material layer 11 of Embodiment 1 can be used as appropriate.

The shape of the solid electrolyte included in the solid electrolyte layer 13 is not particularly limited, and may be acicular, spherical, ellipsoidal, flaky, or the like. The shape of the solid electrolyte included in the solid electrolyte layer 13 may be particulate.

In the case where the shape of the solid electrolyte included in the solid electrolyte layer 13 is particulate (e.g., spherical), the solid electrolyte may have a median diameter of 0.1 μm or more and 10 μm or less. In the case where the particles of the solid electrolyte have a median diameter within such a range, the solid electrolyte layer 13 is less prone to the generation of pinholes and the solid electrolyte layer 13 having a uniform thickness is easily formed.

The solid electrolyte layer 13 may include a conductive additive, a binder, and the like, as necessary. As the conductive additive and the binder, those described for the negative electrode active material layer 11 of Embodiment 1 can be used as appropriate.

The solid electrolyte layer 13 may have a thickness of 15 μm or more and 60 μm or less. In this case, the number of particles of the solid electrolyte included in the thickness direction of the solid electrolyte layer 13 may be three or more.

### EXAMPLES

The present disclosure will be described in detail below with use of comparative examples and examples.

First, using Comparative Example 1 and Example 1 described below, the effect of reducing the reaction resistance by the coating with the carbon material was verified in the case where the ratio R_{D/G} was 1.5 or more in a region in which the negative electrode potential was 0.2 V (vs. Li/Li⁺) or lower.

### [Evaluation of Physical Properties of Active Material]

The negative electrode active material of Comparative Example 1 and the coated active material of Example 1 described below were measured for physical properties, such as the BET specific surface area, the ratio R_{D/G}, and the full width half maximum value Δv_{G}, by the measuring methods mentioned above.

### Comparative Example 1

The negative electrode active material used as Comparative Example 1 was a spheroidized natural graphite obtained by folding a natural flake graphite into a spherical shape for granulating with a hybridization device. This spheroidized natural graphite is referred to as “spheroidized natural graphite A”. The spheroidized natural graphite A had a median diameter of 10.6 μm, an average area equivalent diameter of 0.90, an aspect ratio of 0.66, a geometric specific surface area of 0.23 m²/g, and a BET specific surface area of 6.06 m²/g. The spheroidized natural graphite A had a ratio R_{D/G} of 0.54 and a full width half maximum value Δv_{G} of 18.3 cm⁻¹ determined by Raman spectroscopy.

### Example 1

The spheroidized natural graphite A serving as the core material was coated with the carbon material by the above-mentioned rotational flow CVD method. A gas mixture composed of 30% of propane and 70% of nitrogen was used as the source gas. Conditions were set so that the flow rate was 5 mL/second, the temperature was 800° C., and the processing time was 20 minutes. Thus, the coated active material of Example 1 was obtained. The ratio of the mass of the carbon material to the mass of the coated active material was 3.9%. Note that the ratio of the mass of the carbon material to the mass of the coated active material was determined by measuring, with a precision electronic balance, the increase in the mass of the spheroidized natural graphite A, which was the core powder, between before and after the spheroidized natural graphite A was coated with the carbon material. The coated active material had a median diameter, an average area equivalent diameter, an aspect ratio, and a geometric specific surface area equivalent to those of the spheroidized natural graphite A serving as the core material. In contrast, the BET specific surface area was 4.07 m²/g, decreasing to approximately two thirds of that of the spheroidized natural graphite A. This is conceivably because that a part of pores inside the particles of the spheroidized natural graphite A serving as the core material was covered with the carbon material. The coated active material had a ratio R_{D/G} of 0.54 and a full width half maximum value Δv_{G} of 18.3 cm⁻¹ determined by Raman spectroscopy.

### [Procedure for Producing Lithium-Indium Counter Electrode Half Cell]

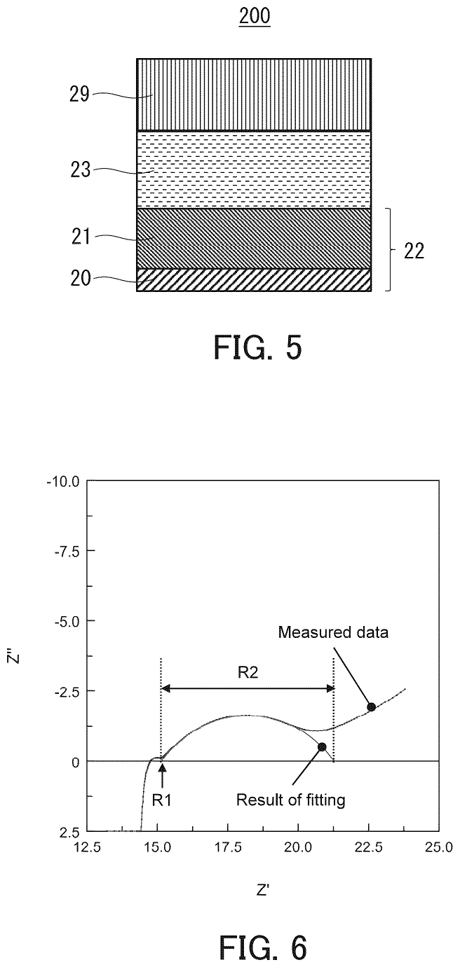

FIG. 5 is a cross-sectional view schematically showing the configuration of a lithium-indium counter electrode half cell 200 of the negative electrode active material layer. Hereinafter, the procedure for producing the half cell 200 will be described in detail.

First, into a hollow Macor with a hole of 1 cm², 100 mg of powder of a solid argyrodite-type sulfide electrolyte (hereinafter referred to as solid sulfide electrolyte A) was put, and pressed at a pressure of 1 tf/cm² for 1 minute for primary molding of a solid electrolyte layer 23. Next, the negative electrode active material (Comparative Example 1) or the coated active material (Example 1) was mixed with the solid sulfide electrolyte A having a small particle diameter in such a manner as to achieve a volume ratio of 50%:50%, and a powdered negative electrode mixture was thus produced. On the lower side of the solid electrolyte layer 23 obtained by the primary molding, 11.4 mg of the powdered negative electrode mixture was put, pressed at a pressure of 1 tf/cm² for 1 minute for primary molding of a negative electrode active material layer 21, and then pressed at a pressure of 6 tf/cm² for 1 minute for main molding. After the main molding ended, the pressure of 6 tf/cm² was released once. On the lower side of the negative electrode active material layer 21, a stainless steel sheet was disposed as a negative electrode current collector 20, pressed at a pressure of 1 tf/cm² for 1 minute, and constrained at a pressure of 1.53 tf/cm² with a constraining jig. On the upper side of the solid electrolyte layer 23, a lithium-indium counter electrode 29 was put, pressed at a pressure of 1 tf/cm² for 1 minute, constrained at a pressure of 1.53 tf/cm² with a constraining jig, and left at 25° C. for 8 hours in order to allow the lithium-indium alloying to proceed.

### <Method for Measuring Cumulative Irreversible Capacity and Reversible Capacity>

The cumulative irreversible capacity and the reversible capacity were measured by the following method.

The half cell 200 shown in FIG. 5 was kept in a constant temperature bath (25° C.) for 8 hours or longer, and then charged at a constant current of 0.22 mA/cm² with a cut-off voltage of −0.57 V. After reaching the cut-off voltage, the half cell 200 was charged at a constant voltage of −0.57 V with a cut-off current of 0.02 mA/cm². After being left in the state of open circuit for 30 minutes, the half cell 200 was discharged at a constant current of 0.22 mA/cm² with a cut-off voltage of +0.88 V. After reaching the cut-off voltage, the half cell 200 was discharged at a constant voltage of +0.88 V with a cut-off current of 0.02 mA/cm². The half cell 200 was left in the state of open circuit for 30 minutes. This charge and discharge cycle was repeated 3 times, and the difference between the sum of the charge capacities for three times and the sum of the discharge capacities for three times was defined as the cumulative irreversible capacity. Also, the discharge capacity at the third time was defined as the reversible capacity.

### [Evaluation of Cumulative Irreversible Capacity and Reversible Capacity Using Half Cell]

In accordance with the above-mentioned production procedure, two units of the half cells 200 (N=1, N=2) were produced using the negative electrode active material of Comparative Example 1, and two units of the half cells 200 (N=1, N=2) were produced using the coated active material of Example 1. The produced half cells 200 were measured for the cumulative irreversible capacity and the reversible capacity in accordance with the above-mentioned method.

The results obtained by the above measurements are shown in Table 1.

TABLE 1

| | Comparative | | | |
|---|---|---|---|---|
| | Example 1 | | Example 1 | |
| Negative electrode active | Spheroidized natural | | Spheroidized natural | |
| material | graphite A | | graphite A | |
| Method for coating with | — | | Rotational flow CVD | |
| carbon material | | | method | |
| Median diameter [μm] | 10.6 | | (Comparable to | |
| | | | Comparative Example 1) | |
| BET specific surface area | 6.06 | | 4.07 | |
| [m²/g] | | | | |
| Geometric specific | 0.234 | | (Comparable to | |
| surface area [m²/g] | | | Comparative Example 1) | |
| Ratio R_{D/G} | 0.54 | | 2.05 | |
| Full width half maximum | 18.3 | | 26.1 | |
| value Δv_{G} [cm⁻¹] | | | | |
| Cumulative irreversible | 25.0 | 26.2 | 18.3 | 20.3 |
| capacity [mAh/g] | (N = 1) | (N = 2) | (N = 1) | (N = 2) |
| Reversible capacity | 341.2 | 343.2 | 334.9 | 333.6 |
| [mAh/g] | (N = 1) | (N = 2) | (N = 1) | (N = 2) |

### <Method for Measuring Reaction Resistance>

The reaction resistance was measured by the following method.

After the completion of the three-time charge and discharge cycles mentioned above, the half cell 200 (N=1) was kept in a constant temperature bath for 24 hours or longer. Thereafter, the half cell 200 was shifted to the state of open circuit, the voltage amplitude was set to 10 mV and the frequency range was set to 7 MHz to 100 mHz, and an alternating-current impedance measurement was performed using the open-circuit voltage as the center voltage with VMP300 manufactured by Bio-Logic SAS. Next, the half cell 200 was charged for 1 hour at a constant current of 0.22 mA/cm². The half cell 200 was left in the state of open circuit for 5 minutes, the voltage amplitude was set to 10 mV and the frequency range was set to 7 MHz to 100 mHz, and then an alternating-current impedance measurement was performed using the open-circuit voltage as the main voltage. The one-hour charge and alternating-current impedance measurement were repeated 10 times. Next, the half cell 200 was left in the state of open circuit for 5 minutes, and then charged at a constant current of 0.22 mA/cm² with a cut-off voltage of −0.57 V. After reaching the cut-off voltage, the half cell 200 was charged at a constant voltage of −0.57 V with a cut-off current of 0.02 mA/cm². The half cell 200 was left in the state of open circuit for 5 minutes, and then an alternating-current impedance measurement was performed. Finally, the half cell 200 was discharged at a constant current of 0.22 mA/cm² with a cut-off voltage of +0.88 V. After reaching the cut-off voltage, the half cell 200 was discharged at a constant voltage of +0.88 V with a cut-off current of 0.02 mA/cm². The half cell 200 was left in the state of open circuit for 5 minutes, and then an alternating-current impedance measurement was performed. The alternating-current impedance measurement was performed at a room temperature (25° C.) first, and then performed at 0° C., −20° C., and 60° C. in this order by changing the temperature of the constant temperature bath.

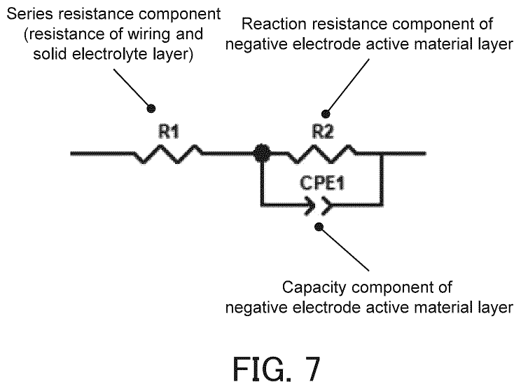

FIG. 6 is a graph showing the Cole-Cole plot obtained by the impedance measurement of the half cell 200 (N=1) of Example 1 at a room temperature (25° C.), together with peak fitting thereof. FIG. 7 is a diagram showing an equivalent circuit of the half cell 200 shown in FIG. 5. By fitting the Cole-Cole plot in FIG. 6, at a chosen area around the top of the arc thereof, with the equivalent circuit shown in FIG. 7, a resistance component R₂ of the negative electrode active material layer 21 was calculated. According to the studies by the present inventors, the calculated resistance component R₂ is a resistance component obtained by adding: a reaction resistance R_{B} of melting precipitation of lithium between the lithium-indium counter electrode 29 and the solid electrolyte layer 23; and a reaction resistance R_{A} of the intercalation and de-intercalation of lithium between the solid electrolyte layer 23 and the negative electrode active material layer 21. As for resistance components added together in the same frequency band, a method that separates them mathematically using a DRT analysis is proposed. The reaction resistance R_{A} tends to increase as the charge rate of the negative electrode active material layer 21 increases, that is, as the potential of the negative electrode active material layer 21 lowers. Especially, the reaction resistance R_{A} becomes higher than the reaction resistance R_{B} in a potential region in which the potential of the negative electrode active material layer 21 is lower than 0.2 V (vs. Li/Li⁺). Based on this, fitting with the equivalent circuit shown in FIG. 7 was performed without performing a DRT analysis, and the obtained resistance component R₂ was regarded as the reaction resistance R_{A}.

### [Evaluation of Reaction Resistance Using Half Cell]

Using the half cells 200 (N=1) of Comparative Example 1 and Example 1, the effect of reducing the reaction resistance R_{A} by the coating with the carbon material was verified.

After the completion of the three-time charge and discharge cycles mentioned above, alternating-current impedance was measured, from the discharge state to the charge state, every time the one-hour charge was performed at a constant current of 0.22 mA/cm². Thereby, measurements were made at a room temperature (25° C.), 0° C., −20° C., and 60° C. in this order to see how the reaction resistance R_{A} changed in the negative electrode active material layer 21 as the half cell 200 shifted from the discharge state to the charge state.

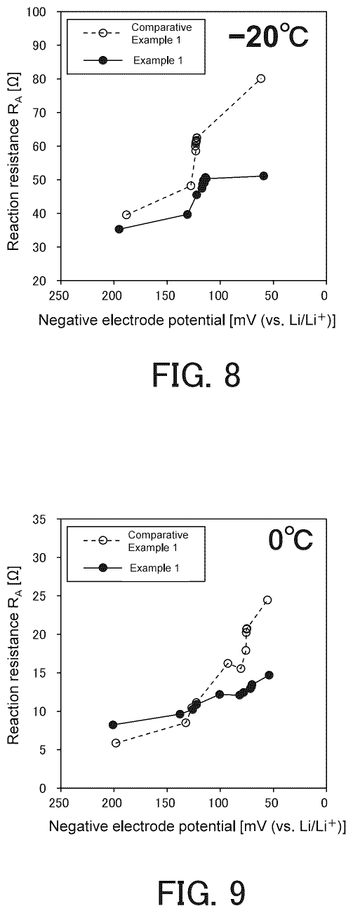

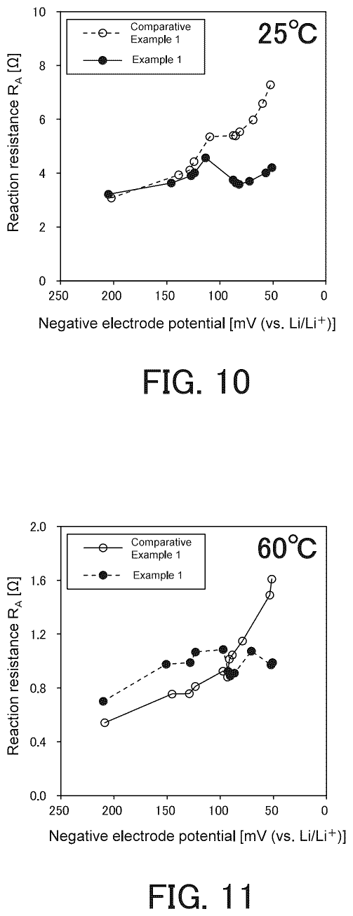

The results obtained by measuring the reaction resistance R_{A} at each temperature as above are shown in FIG. 8 to FIG. 11. In FIG. 8 to FIG. 11, the horizontal axis indicates a negative electrode potential (vs. Li/Li⁺) obtained by converting (by adding 0.62 V to) the center voltage based on the lithium-indium counter electrode at a low frequency into the center voltage based on a lithium metal in each alternating-current impedance measurement. The vertical axis indicates the value of the reaction resistance R_{A} obtained by fitting with the equivalent circuit.

In Comparative Example 1 in which the spheroidized natural graphite A was not coated with the carbon material, the reaction resistance R_{A} sharply increased as the charge rate increased and the negative electrode potential lowered. In contrast, in Example 1 in which the spheroidized natural graphite A was coated with the carbon material having a ratio R_{D/G} of 2.05, the sharp increase in the reaction resistance R_{A} was suppressed. In Example 1, the cumulative irreversible capacity was also suppressed to be low by the coating with the carbon material.

Next, using Comparative Example 2 to Comparative Example 4, Example 2, and Example 3 described below, the effect of reducing the cumulative irreversible capacity by the coating with the carbon material in the case where the ratio R_{D/G} was 1.5 or more was verified.

### [Evaluation of Physical Properties of Active Material]

The negative electrode active materials of Comparative Example 2 to Comparative Example 4, the coated active materials of Comparative Example 5 to Comparative Example 6, and the coated active materials of Example 2 and Example 3 described below were measured for physical properties, such as the BET specific surface area, the ratio R_{D/G}, and the full width half maximum value Δv_{G}, by the measuring methods mentioned above.

### Comparative Example 2

The negative electrode active material of Comparative Example 2 used was a spheroidized natural graphite that was the same in raw ore as the spheroidized natural graphite A and obtained by further granulation using a hybridization device as compared with the spheroidized natural graphite A. This spheroidized natural graphite is referred to as “spheroidized natural graphite B.” The spheroidized natural graphite B had a median diameter of 15.8 μm, an average area equivalent diameter of 0.93, an aspect ratio of 0.70, a geometric specific surface area of 0.16 m²/g, and a BET specific surface area of 5.29 m²/g. The spheroidized natural graphite B had a ratio R_{D/G} of 0.73 and a full width half maximum value Δv_{G} of 19.6 cm⁻¹ determined by Raman spectroscopy.

### Comparative Example 3

The negative electrode active material of Comparative Example 3 used was a spheroidized natural graphite that was different in raw ore from the spheroidized natural graphite A and the spheroidized natural graphite B, and obtained by folding a natural flake graphite into a spherical shape for granulating with a hybridization device. This spheroidized natural graphite is referred to as “spheroidized natural graphite C.” The spheroidized natural graphite C had a median diameter of 11.4 μm, an average area equivalent diameter of 0.94, an aspect ratio of 0.69, a geometric specific surface area of 0.21 m²/g, and a BET specific surface area of 5.95 m²/g. The spheroidized natural graphite C had a ratio R_{D/G} of 0.43 and a full width half maximum value Δv_{G} of 18.6 cm⁻¹ determined by Raman spectroscopy.

### Comparative Example 4

The negative electrode active material of Comparative Example 4 used was a spheroidized natural graphite that was different in raw ore from the spheroidized natural graphite A and the spheroidized natural graphite B, and obtained by folding a natural flake graphite into a spherical shape for granulating with a hybridization device. This spheroidized natural graphite is referred to as “spheroidized natural graphite D.” The spheroidized natural graphite D had a median diameter of 18.4 μm, an average area equivalent diameter of 0.92, an aspect ratio of 0.69, a geometric specific surface area of 0.13 m²/g, and a BET specific surface area of 4.35 m²/g. The spheroidized natural graphite D had a ratio R_{D/G} of 0.53 and a full width half maximum value Δv_{G} of 19.5 cm⁻¹ determined by Raman spectroscopy.

### Comparative Example 5

The spheroidized natural graphite A serving as the core material was coated with a few mass % of the carbon material using petroleum pitch as a precursor of the carbon material. Thus, the coated active material of Comparative Example 5 was obtained. The coated active material had a median diameter of 12.5 μm, an average area equivalent diameter of 0.92, an aspect ratio of 0.66, a geometric specific surface area of 0.23 m²/g, and a BET specific surface area of 2.27 m²/g. The coated active material had a ratio R_{D/G} of 0.55 and a full width half maximum value Δv_{G} of 18.8 cm⁻¹ determined by Raman spectroscopy.

### Comparative Example 6

The spheroidized natural graphite B serving as the core material was coated with a few mass % of the carbon material by using petroleum pitch as a precursor of the carbon material. Thus, the coated active material of Comparative Example 6 was obtained. The coated active material had a median diameter of 16.9 μm, an average area equivalent diameter of 0.94, an aspect ratio of 0.71, a geometric specific surface area of 0.17 m²/g, and a BET specific surface area of 2.29 m²/g. The coated active material had a ratio R_{D/G} of 1.38 and a full width half maximum value Δv_{G} of 22.9 cm⁻¹ determined by Raman spectroscopy.

### Example 2

The spheroidized natural graphite B serving as the core material was coated with the carbon material by the above-mentioned rotational flow CVD method. A gas mixture of ethane and nitrogen was used as the source gas. Conditions were set so that the ethane flow rate was 150 sccm, the nitrogen flow rate was 300 sccm, the pressure was 1 atmospheric pressure, the temperature was 800° C., and the processing time was 30 minutes. Thus, the coated active material of Example 2 was obtained. The ratio of the mass of the carbon material to the mass of the coated active material was 5.50%. The coated active material had a median diameter of approximately 16 μm, an average area equivalent diameter of 0.94, an aspect ratio of 0.71, a geometric specific surface area of 0.15 m²/g, and a BET specific surface area of 2.98 m²/g. The coated active material had a ratio R_{D/G} of 2.95 and a full width half maximum value Δv_{G} of 37.2 cm⁻¹ determined by Raman spectroscopy.

### Example 3

The spheroidized natural graphite B serving as the core material was coated with the carbon material by the above-mentioned rotational flow CVD method. A gas mixture of ethane and nitrogen was used as the source gas. Conditions were set so that the ethane flow rate was 400 sccm, the nitrogen flow rate was 200 sccm, the pressure was 0.2 atmospheric pressure, the temperature was 850° C., and the processing time was 42 minutes. Thus, the coated active material of Example 3 was obtained. The ratio of the mass of the carbon material to the mass of the coated active material was 10.2%. The coated active material had a median diameter of approximately 16 μm, an average area equivalent diameter of 0.94, an aspect ratio of 0.71, a geometric specific surface area of 0.16 m²/g, and a BET specific surface area of 2.60 m²/g. The coated active material had a ratio R_{D/G} of 2.91 and a full width half maximum value Δv_{G} of 55.8 cm⁻¹ determined by Raman spectroscopy.

### [Evaluation of Cumulative Irreversible Capacity and Reversible Capacity Using Half Cell]

Using respectively the negative electrode active materials of Comparative Example 2 to Comparative Example 4 and the coated active materials of Comparative Example 5, Comparative Example 6, Example 2, and Example 3, the half cells 200 were produced in accordance with the above-mentioned production procedure. Except for Comparative Examples 3 and 4, two units of the half cells 200 (N=1, N=2) were produced. The produced half cells 200 were measured for the cumulative irreversible capacity and the reversible capacity in accordance with the above-mentioned method.

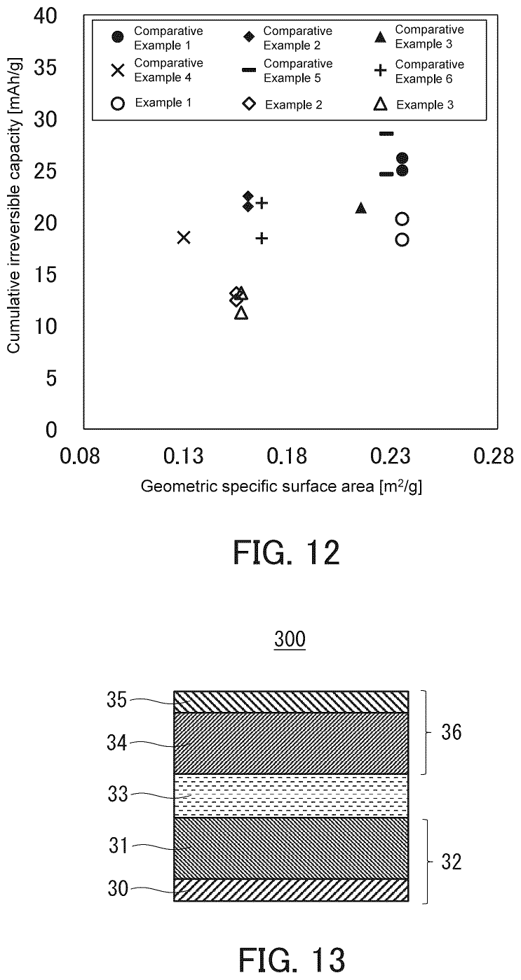

Evaluation of the cumulative irreversible capacity requires to be conducted carefully in the case where the negative electrode active materials have different median diameters. When the negative electrode active materials have different median diameters, they have different BET specific surface areas and different geometric specific surface areas, and thus the area of contact between each negative electrode active material and the solid electrolyte is different. FIG. 12 shows the relation between the cumulative irreversible capacity and the geometric specific surface area in each of Comparative Example 1 to Comparative Example 6 and Example 1 to Example 3. Comparative Example 1, Comparative Example 3, Comparative Example 5, and Example 1 each had a median diameter of approximately 10 μm, and they also had similar geometric specific surface areas. Comparing the cumulative irreversible capacities of Comparative Example 1, Comparative Example 3, Comparative Example 5, and Example 1, the cumulative irreversible capacity of Example 1 decreased most. Comparative Example 2, Comparative Example 4, Comparative Example 6, Example 2, and Example 3 each had a median diameter of approximately from 16 μm to 18 μm, and they also had similar geometric specific surface areas. Comparing the cumulative irreversible capacities of Comparative Example 2, Comparative Example 4, Comparative Example 6, Example 2, and Example 3, those of Example 1 and Example 3 decreased most.

It is inferred that in Example 1 to Example 3, the negative electrode active material was coated with the carbon material having a ratio R_{D/G} of 1.5 or more, so that the reaction active sites for lithium ions became dense on the surface of the negative electrode active material, and thus the irreversible capacity resulting from the reductive decomposition of the solid electrolyte was reduced.

The results obtained by the above measurements are shown in Table 2.

TABLE 2

| | Comparative | | Comparative | | Comparative | | Comparative | | Comparative | | | | | |
|---|---|---|---|---|---|---|---|---|---|---|---|---|---|---|
| | Example 2 | | Example 3 | | Example 4 | | Example 5 | | Example 6 | | Example 2 | | Example 3 | |
| Negative | Spheroidized | | Spheroidized | | Spheroidized | | Spheroidized | | Spheroidized | | Spheroidized | | Spheroidized | |
| electrode active | natural | | natural | | natural | | natural | | natural | | natural | | natural | |
| material | graphite B | | graphite C | | graphite D | | graphite A | | graphite B | | graphite B | | graphite B | |
| Method for | — | | — | | — | | Petroleum | | Petroleum | | Rotational | | Rotational | |
| coating with | | | | | | | pitch | | pitch | | flow CVD | | flow CVD | |
| carbon material | | | | | | | | | | | method | | method | |
| Median diameter | 15.8 | | 11.4 | | 18.4 | | 12.5 | | 16.9 | | Approx. 16 | | Approx. 16 | |
| [μm] | | | | | | | | | | | | | | |
| BET specific | 5.29 | | 5.95 | | 4.35 | | 2.27 | | 2.29 | | 2.98 | | 2.60 | |
| surface area | | | | | | | | | | | | | | |
| [m²/g] | | | | | | | | | | | | | | |
| Geometric | 0.16 | | 0.21 | | 0.13 | | 0.23 | | 0.17 | | 0.15 | | 0.16 | |
| specific surface | | | | | | | | | | | | | | |
| area | | | | | | | | | | | | | | |
| [m²/g] | | | | | | | | | | | | | | |
| Ratio R_{D/G} | 0.73 | | 0.43 | | 0.53 | | 0.55 | | 1.38 | | 2.95 | | 2.91 | |
| Full width half | 19.6 | | 18.6 | | 19.5 | | 18.8 | | 22.9 | | 37.2 | | 55.8 | |
| maximum value | | | | | | | | | | | | | | |
| Δv_{G} [cm⁻¹] | | | | | | | | | | | | | | |
| Cumulative | 22.5 | 21.5 | 21.4 | — | 18.5 | — | 28.5 | 24.6 | 21.8 | 18.4 | 12.4 | 13.1 | 11.2 | 13.1 |
| irreversible | (N = 1) | (N = 2) | (N = 1) | | (N = 1) | | (N = 1) | (N = 2) | (N = 1) | (N = 2) | (N = 1) | (N = 2) | (N = 1) | (N = 2) |
| capacity | | | | | | | | | | | | | | |
| [mAh/g] | | | | | | | | | | | | | | |
| Reversible | 342.0 | 341.0 | 343.5 | — | 343.5 | — | 331.3 | 332.2 | 328.9 | 336.6 | 326.8 | 332.2 | 318.6 | 326.4 |
| capacity | (N = 1) | (N = 2) | (N = 1) | | (N = 1) | | (N = 1) | (N = 2) | (N = 1) | (N = 2) | (N = 1) | (N = 2) | (N = 1) | (N = 2) |
| [mAh/g] | | | | | | | | | | | | | | |

Next, using Comparative Example 7, Comparative Example 8, Example 4, and Example 5 described below, the improvement of the load characteristics by the coating with the carbon material in the case where the ratio R_{D/G} was 1.5 or more was verified.

### [Evaluation of Physical Properties of Active Material]

The negative electrode active material of Comparative Example 7 and the coated active materials of Comparative Example 8, Example 4, and Example 5 described below were measured for physical properties, such as the BET specific surface area, the ratio R_{D/G}, and the full width half maximum value Δv_{G}, by the measuring methods mentioned above. Note that, as described later, the coated active materials of Example 4 and Example 5 were respectively additional test samples of the coated active materials of Example 2 and Example 3. Therefore, Example 4 and Example 5 were regarded to have median diameters, average area equivalent diameters, aspect ratios, geometric specific surface areas, and BET specific surface areas respectively equal to those of the coated active materials of Example 2 and Example 3, and were measured only for the ratio R_{D/G} and the full width half maximum value Δv_{G}.

### Comparative Example 7

The spheroidized natural graphite B was used as the negative electrode active material of Comparative Example 7.

### Comparative Example 8

The coated active material of Comparative Example 6 was used as the coated active material of Comparative Example 8.

### Example 4

The spheroidized natural graphite B serving as the core material was coated with the carbon material by the above-mentioned rotational flow CVD method. A gas mixture of ethane and nitrogen was used as the source gas. Conditions were set so that the ethane flow rate was 150 sccm, the nitrogen flow rate was 300 sccm, the pressure was 1 atmospheric pressure, the temperature was 800° C., and the processing time was 55 minutes. Thus, the coated active material of Example 4 was obtained. The ratio of the mass of the carbon material to the mass of the coated active material was 4.58%. The coated active material had a ratio R_{D/G} of 3.07 and a full width half maximum value Δv_{G} of 28.9 cm⁻¹ determined by Raman spectroscopy.

### Example 5

The spheroidized natural graphite B serving as the core material was coated with the carbon material by the above-mentioned rotational flow CVD method. A gas mixture of ethane and nitrogen was used as the source gas. Conditions were set so that the ethane flow rate was 400 sccm, the nitrogen flow rate was 200 sccm, the pressure was 0.2 atmospheric pressure, the temperature was 850° C., and the processing time was 68 minutes. Thus, the coated active material of Example 5 was obtained. The ratio of the mass of the carbon material to the mass of the coated active material was 9.49%. The coated active material had a ratio R_{D/G} of 3.02 and a full width half maximum value Δv_{G} of 42.2 cm⁻¹ determined by Raman spectroscopy. The results obtained by the above measurements are shown in Table 3.

TABLE 3

| | Comparative | Comparative | | |
|---|---|---|---|---|
| | Example 7 | Example 8 | Example 4 | Example 5 |
| Negative | Spheroidized | Spheroidized | Spheroidized | Spheroidized |
| electrode active | natural | natural | natural | natural |
| material | graphite B | graphite B | graphite B | graphite B |
| Method for | — | Petroleum | Rotational | Rotational |
| coating with | | pitch | flow CVD | flow CVD |
| carbon material | | | method | method |
| Median | 15.8 | 16.9 | Approx. 16 | Approx. 16 |
| diameter | | | | |
| [μm] | | | | |
| Ratio R_{D/G} | 0.73 | 1.38 | 3.07 | 3.02 |
| Full width half | 19.6 | 22.9 | 28.9 | 42.2 |
| maximum | | | | |
| value | | | | |
| Δv_{G} [cm⁻¹] | | | | |

[Procedure for Producing Laminated Battery with Counter Electrode NCM Positive Electrode]

FIG. 13 is a cross-sectional view schematically showing the configuration of a laminated battery 300 with a counter electrode NCM positive electrode. Hereinafter, the procedure for producing the laminated battery 300 will be explained in detail.

First, a negative electrode active material layer 31, a positive electrode active material layer 34, and a solid electrolyte layer 33 were produced in accordance with the following production procedure.

The negative electrode active material (Comparative Example 7) or the coated active material (Comparative Example 8, Example 4 to Example 5), the solid argyrodite-type sulfide electrolyte (hereinafter referred to as the solid sulfide electrolyte B), and a binder were mixed in an organic solvent in a predetermined composition ratio and dispersed to prepare a negative electrode coating slurry. The negative electrode coating slurry was applied onto a negative electrode current collector 30 so as to have a thickness that allows to achieve a target capacity. The resultant was subjected to a vacuum drying treatment to evaporate the organic solvent, and was punched into a predetermined size to produce a negative electrode 32. The produced negative electrode 32 was measured for weight with a precision balance, and the capacity of the negative electrode 32 was calculated from the measured value. Thereby, observation was made to see whether the capacity was not significantly away from the target capacity.

NCM523 was used as the positive electrode active material included in the positive electrode active material layer. VGCF (registered trademark) was used as the conductive additive. The positive electrode active material, the solid sulfide electrolyte B, the conductive additive, and a binder were mixed in an organic solvent in a predetermined composition ratio and dispersed to prepare a positive electrode coating slurry. The positive electrode coating slurry was applied onto a positive electrode current collector 35 so as to have a thickness that allows to achieve a target capacity. The resultant was subjected to a vacuum drying treatment to evaporate the organic solvent, and was punched into a predetermined size to produce a positive electrode 36. The produced positive electrode 36 was measured for weight with a precision balance, and the capacity of the positive electrode 36 was calculated from the measured value. Thereby, observation was made to see whether the capacity was not significantly away from the target capacity.

The capacity of the negative electrode 32 and the capacity of the positive electrode 36 calculated from the measured values of weights were away from the target capacities, varying in the range of approximately ±5%. Therefore, several pieces of the negative electrodes 32 and several pieces of the positive electrodes 36 were punched out and a combination of the negative electrode 32 and the positive electrode 36 was selected beforehand so that the ratio between the capacity of the negative electrode 32 and the capacity of the positive electrode 36 was 1.10.

Next, the solid sulfide electrolyte A and a binder were mixed in an organic solvent in a predetermined composition ratio and dispersed to prepare a solid electrolyte coating slurry. The solid electrolyte coating slurry was applied onto a stainless steel foil serving as a support member. The resultant was subjected to a vacuum drying treatment to evaporate the organic solvent, and was punched into a predetermined size to produce the solid electrolyte layer 33.

Next, the solid electrolyte layer 33 applied onto the support member was allowed to adhere to the negative electrode 32 in a direction in which their coating films lie on each other, and the resultant was pressed at a predetermined temperature and a linear pressure. The solid electrolyte layer 33 was thereby transferred to the negative electrode active material layer 31, and the support member was peeled off from the solid electrolyte layer 33.

Next, the negative electrode 32 with the solid electrolyte layer 33 transferred thereto was allowed to adhere to the positive electrode 36 in a direction in which their coating films lie on each other, the resultant was put in a laminate material in a state in which a tab lead for terminal connection was pulled out, and it was vacuum-sealed. The vacuum-sealed laminated battery was pressed at a predetermined temperature, sandwiched between stainless steel metal plates for constraining, and constrained at a predetermined constraining pressure. Thus, the laminated battery 300 was obtained.

### <Method for Measuring Load Characteristics>

The load characteristics of the laminated battery 300 were measured by the following method.

First, the following charge and discharge operations were performed 3 times in a state in which the laminated battery 300 was kept in a constant temperature bath (25° C.). A current density corresponding to the charge/discharge rate was calculated based on the capacity of the positive electrode 36 calculated from the measured value of weight. Constant current charge was performed for the laminated battery 300 at a constant current density of 316 μA/cm² equivalent to 0.1 C with a cut-off voltage of 4.20 V. After reaching the cut-off voltage, constant voltage charge was performed for the laminated battery 300 at a voltage of 4.20 V with a cut-off current of 31.6 μA/cm². After reaching the cut-off current, the laminated battery 300 was left in the state of open circuit for 30 minutes. Thereafter, constant current discharge was performed for the laminated battery 300 at a constant current density of 316 μA/cm² equivalent to 0.1 C with a cut-off voltage of 3.00 V. After reaching the cut-off voltage, constant voltage discharge was performed for the laminated battery 300 at a voltage of 3.00 V with a cut-off current of 31.6 μA/cm². After reaching the cut-off current, the laminated battery 300 was left in the state of open circuit for 30 minutes. This charge and discharge operations were repeated 3 times.

Next, constant current charge was performed for the laminated battery 300 at a constant current density of 316 μA/cm² equivalent to 0.1 C with a cut-off voltage of 4.20 V. After reaching the cut-off voltage, the laminated battery 300 was left in the state of open circuit for 30 minutes. Thereafter, constant current discharge was performed for the laminated battery 300 at a constant current density of 316 μA/cm² equivalent to 0.1 C with a cut-off voltage of 3.00 V. After reaching the cut-off voltage, constant voltage discharge was performed for the laminated battery 300 at a voltage of 3.00 V with a cut-off current of 31.6 μA/cm². After reaching the cut-off current, the laminated battery 300 was left in the state of open circuit for 30 minutes. Next, constant current charge was performed for the laminated battery 300 at a constant current density of 3.16 mA/cm² equivalent to 1 C with a cut-off voltage of 4.20 V. After reaching the cut-off voltage, the laminated battery 300 was left in the state of open circuit for 30 minutes. Thereafter, constant current discharge was performed for the laminated battery 300 at a constant current density of 316 μA/cm² equivalent to 0.1 C with a cut-off voltage of 3.00 V. After reaching the cut-off voltage, constant voltage discharge was performed for the laminated battery 300 at a voltage of 3.00 V with a cut-off current of 31.6 μA/cm². After reaching the cut-off current, the laminated battery 300 was left in the state of open circuit for 30 minutes. Next, constant current charge was performed for the laminated battery 300 at a constant current density of 6.32 mA/cm² equivalent to 2 C with a cut-off voltage of 4.20 V. After reaching the cut-off voltage, the laminated battery 300 was left in the state of open circuit for 30 minutes. Thereafter, constant current discharge was performed for the laminated battery 300 at a constant current density of 316 μA/cm² equivalent to 0.1 C with a cut-off voltage of 3.00 V. After reaching the cut-off voltage, constant voltage discharge was performed for the laminated battery 300 under a voltage of 3.00 V with a cut-off current of 31.6 μA/cm². After reaching the cut-off current, the laminated battery 300 was left in the state of open circuit for 30 minutes. In such a procedure, four to six units of the laminated batteries 300 (N=4 to 6) were measured for load characteristics at 60° C., 50° C., and 40° C. in this order while the rate was changed only for the charge operation to be at 0.1 C, 1 C, 2 C, 4 C, and 6 C in this order. The evaluation was stopped for any of the laminated batteries 300 broken by a short circuit during the load characteristics measurements, and the load characteristics measurements were continued only for the rest of the laminated batteries 300 that were still workable.

### [Evaluation of Load Characteristics Using Laminated Battery]

The laminated batteries 300 of Comparative Examples 7 and 8 and Examples 4 and 5 were produced using respectively the negative electrode active material of Comparative Example 7, and the coated active materials of Comparative Example 8, Example 4, and Example 5. The produced laminated batteries 300 were measured for load characteristics in accordance with the above-mentioned method.

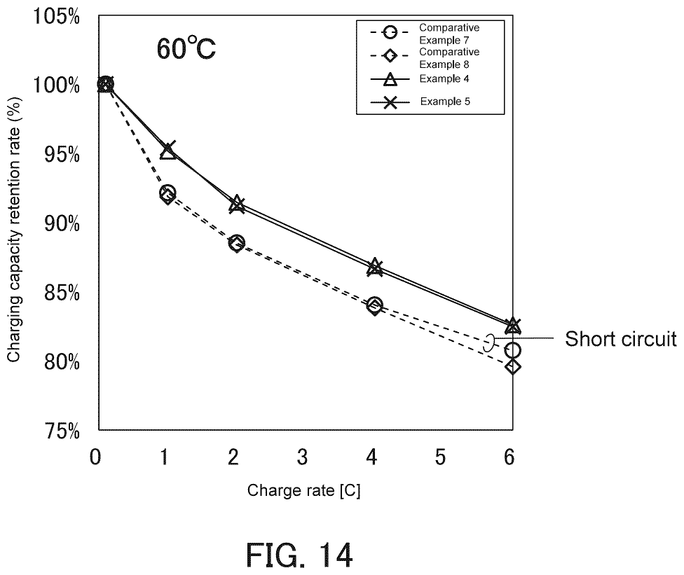

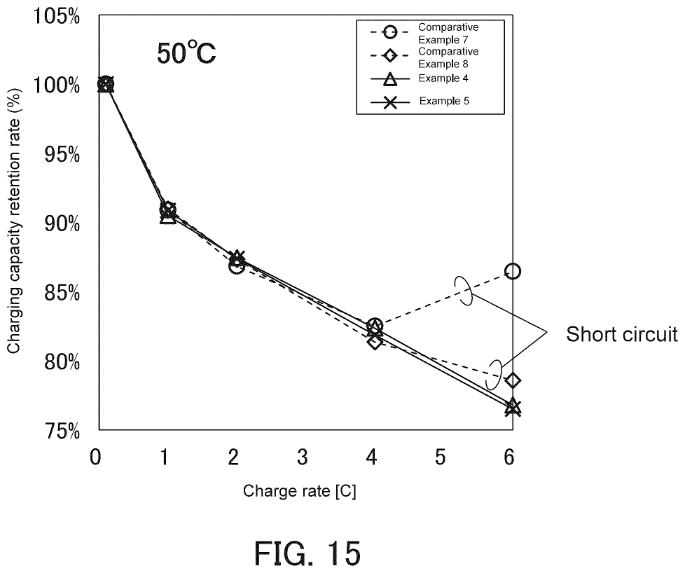

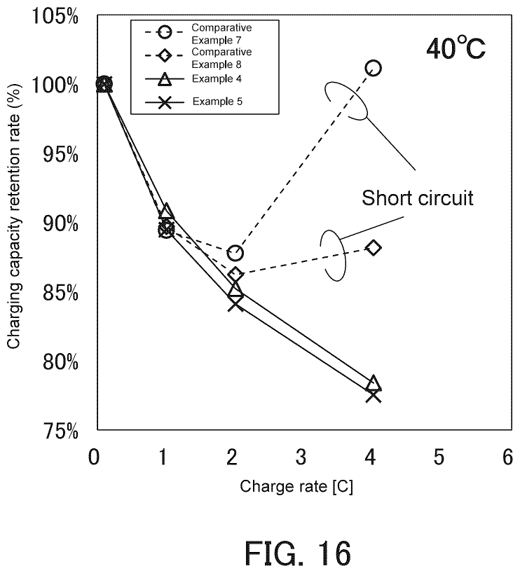

The results obtained by measuring the load characteristics at each temperature are shown in FIG. 14 to FIG. 16. In FIG. 14 to FIG. 16, the horizontal axis indicates the charge rate (C). The vertical axis indicates the percentage of the charge capacity at each rate when the charge capacity in 0.1 C charge is taken as 100%, that is, the charge capacity retention rate (%).

At 60° C., Example 4 and Example 5 each maintained a charge capacity retention rate higher than those of Comparative Example 7 and Comparative Example 8. In Comparative Example 7 in which the coating with the carbon material was not provided, an increase in the apparent capacity that was presumably due to a short circuit was observed in the 6 C charge. However, the short circuit in the 6C charge in Comparative Example 7 was considered not to be a complete short circuit but a minor short circuit, and the following evaluation at 50° C. was continued.

At 50° C., Comparative Example 7 had a complete short circuit in the 6 C charge. In Comparative Example 8 in which the ratio R_{D/G} was less than 1.5, an increase in the apparent capacity that was presumably due to a short circuit was observed in the 6 C charge. In contrast to the fact that a short circuit occurred in the 6 C charge when the ratio R_{D/G} was less than 1.5, no short circuit occurred and the 6 C charge was possible at a high charge capacity retention rate in Example 4 and Example 5 in which the ratio R_{D/G} was 3.0 or more. Note that in Comparative Example 7 and Comparative Example 8 that each had a short circuit, the laminated battery 300 was replaced with a new one and the following evaluation at 40° C. was conducted.

At 40° C., an increase in the apparent capacity that was presumably due to a short circuit was observed in the 2 C charge in Comparative Example 7 and Comparative Example 8. Comparative Example 7 and Comparative Example 8 each had a complete short circuit in the 4 C charge. In contrast to the fact that a short circuit occurred in the 2 C charge in Comparative Example 7 and Comparative Example 8 in which the ratio R_{D/G} was less than 1.5, no short circuit occurred and the 4 C charge was possible at a high charge capacity retention rate in Example 4 and Example 5 in which the ratio R_{D/G} was 1.5 or more.

The above results ascertained that when the negative electrode active material was coated with the carbon material having a ratio R_{D/G} of 1.5 or more, the reaction active sites for lithium ions became dense on the surface of the negative electrode active material, and thus the irreversible capacity resulting from the reductive decomposition of the solid electrolyte was reduced. Furthermore, it was proved that the load characteristics of the battery was also improved, no short circuit occurred even at a high charge rate, and a charge operation at a high charge capacity retention rate was possible.

Next, using Comparative Examples 9 and 10 and Examples 6 to 7 described below, it was verified that the effect of reducing the reaction resistance by the coating with the carbon material was diminished in the case where the ratio R_{D/G} was less than 1.5.

### [Evaluation of Physical Properties of Active Material]

The negative electrode active material of Comparative Example 9 and the coated active materials of Comparative Example 10, Example 6, and Example 7 described below were measured for physical properties, such as the BET specific surface area, the ratio R_{D/G}, and the full width half maximum value Δv_{G}, by the measuring methods mentioned above. Note that as described below, the negative electrode active material of Comparative Example 9 was the spheroidized natural graphite B and the coated active material of Example 6 was the coated active material of Example 4. Therefore, the measurements of the physical properties were omitted for Comparative Example 9 and Example 6.

### Comparative Example 9

The spheroidized natural graphite B was used as the negative electrode active material of Comparative Example 9.

### Example 6

The coated active material of Example 4 was used as the coated active material of Example 6.

### Example 7

The spheroidized natural graphite B serving as the core material was coated with the carbon material by the above-mentioned rotational flow CVD method. A gas mixture of ethane and nitrogen was used as the source gas. Conditions were set so that the ethane flow rate was 150 sccm, the nitrogen flow rate was 300 sccm, the pressure was 1 atmospheric pressure, the temperature was 800° C., and the processing time was 30 minutes. Thus, the coated active material of Example 7 was obtained. The ratio of the mass of the carbon material to the mass of the coated active material was 1.94%. The coated active material had a ratio R_{D/G} of 2.00 and a full width half maximum value Δv_{G} of 26.3 cm⁻¹ determined by Raman spectroscopy.

### Comparative Example 10

The coated active material of Example 7 was kept in an argon gas atmosphere at 150° C. for 2 hours while an argon gas was kept flowing at a predetermined flow rate, and then was subjected to a heat treatment at 1200° C. for 2 hours. Thus, the coated active material of Comparative Example 10 was obtained. The coated active material had a ratio R_{D/G} of 1.27 and a full width half maximum value Δv_{G} of 21.2 cm⁻¹ determined by Raman spectroscopy. It is inferred that adding the heat treatment to the coated active material of Example 7 increased the crystallinity of the carbon material used for coating and lowered the ratio R_{D/G} from 2.00 to 1.27.

### [Evaluation of Cumulative Irreversible Capacity and Reversible Capacity Using Half Cell]

In accordance with the above-mentioned production method, the half cells 200 of Comparative Example 9, Comparative Example 10, Example 6, and Example 7 were produced, two units (N=1, N=2) each, using respectively the negative electrode active material of Comparative Example 9 and the coated active materials of Comparative Example 10, Example 6, and Example 7. The produced half cells 200 were measured for the cumulative irreversible capacity and the reversible capacity in accordance with the above-mentioned measuring method for the cumulative irreversible capacity and the reversible capacity. Note that in the half cells 200, the solid sulfide electrolyte B same as that used for the laminated battery 300 was used as the solid electrolyte included in the negative electrode active material layer 21.

The results obtained by the above measurements are shown in Table 4.

TABLE 4

| | Comparative | | Comparative | | | | | |
|---|---|---|---|---|---|---|---|---|
| | Example 9 | | Example 10 | | Example 6 | | Example 7 | |
| Negative electrode | Spheroidized | | Spheroidized | | Spheroidized | | Spheroidized | |
| active material | natural | | natural | | natural | | natural | |
| | graphite B | | graphite B | | graphite B | | graphite B | |
| Method for coating | — | | Rotational | | Rotational | | Rotational | |
| with carbon material | | | flow CVD | | flow CVD | | flow CVD | |
| | | | method + heat | | method | | method | |
| | | | treatment | | | | | |
| Median diameter | 15.8 | | Approx. 16 | | Approx. 16 | | Approx. 16 | |
| [μm] | | | | | | | | |
| Ratio R_{D/G} | 0.73 | | 1.27 | | 3.07 | | 2.00 | |
| Full width half | 19.6 | | 21.2 | | 28.9 | | 26.3 | |
| maximum value Δv_{G} | | | | | | | | |
| [cm⁻¹] | | | | | | | | |
| Cumulative | 17.6 | 17.5 | 10.3 | 9.5 | 10.2 | 13.8 | 14.2 | 16.8 |
| irreversible capacity | (N = 1) | (N = 2) | (N = 1) | (N = 2) | (N = 1) | (N = 2) | (N = 1) | (N = 2) |
| [mAh/g] | | | | | | | | |
| Reversible capacity | 337.6 | 332.1 | 324.0 | 335.9 | 331.8 | 326.4 | 326.5 | 324.6 |
| [mAh/g] | (N = 1) | (N = 2) | (N = 1) | (N = 2) | (N = 1) | (N = 2) | (N = 1) | (N = 2) |

### [Evaluation of Reaction Resistance Using Half Cell]

After the completion of the three-time charge and discharge cycles mentioned above, alternating-current impedance was measured, from the discharge state to the charge state, every time one-hour charge was performed at a constant current of 0.22 mA/cm². Thereby, a measurement was made at a room temperature (25° C.) to see how the reaction resistance R_{A} changed in the negative electrode active material layer 21 as the half cell 200 shifted from the discharge state to the charge state.

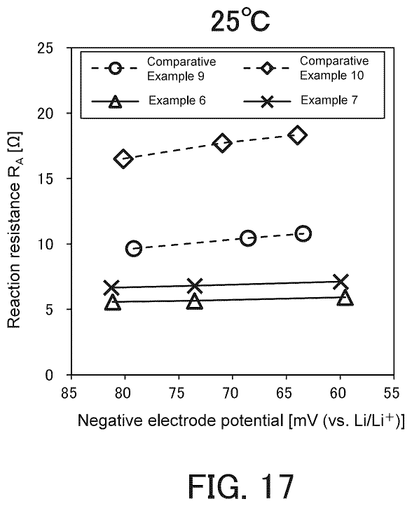

The results obtained by measuring the reaction resistance R_{A} at 25° C. as above are shown in FIG. 17. In FIG. 17, the horizontal axis indicates a negative electrode potential (vs. Li/Li⁺) obtained by converting (by adding 0.62 V to) the center voltage based on the lithium-indium counter electrode at a low frequency into the center voltage based on a lithium metal in each alternating-current impedance measurement. The vertical axis indicates the value of the reaction resistance R_{A} obtained by fitting with the equivalent circuit. FIG. 17 only shows the values in the range of 85 mV to 55 mV.

In Comparative Example 9 in which the spheroidized natural graphite B was not coated with the carbon material and Comparative Example 10 in which the ratio R_{D/G} was less than 1.5, the reaction resistance R_{A} sharply increased as the charge rate increased and the negative electrode potential lowered. In contrast, in Example 6 and Example 7 in which the spheroidized natural graphite B was coated with the carbon material having a ratio R_{D/G} of 2.0 or more, the sharp increase in the reaction resistance R_{A} was suppressed. In Example 6 and Example 7, the cumulative irreversible capacity was also suppressed to be low by the coating with the carbon material.

It is conceived that the cumulative irreversible capacity of Comparative Example 10 was reduced to be lower than the cumulative irreversible capacity of Example 7 for the following reason.

Generally, the nitrogen contained in a CVD source gas makes a nitrogen-carbon compound. Therefore, it is known that a given amount of a nitrogen-carbon compound is included in a carbonaceous substance formed by the CVD method. Particularly, a larger amount of nitrogen remains in the case where the processing time is short or the temperature is low.

When the nitrogen remaining as a compound with carbon reacts with lithium ions, a nitride is generated, leading to an increase in the irreversible capacity. It is inferred that in Example 7 in which the ratio of the mass of the carbon material to the mass of the coated active material was as low as 1.94%, the remaining nitrogen reacted with lithium ions and a nitride was generated, causing an increase in the cumulative irreversible capacity. It is inferred, however, that in Example 7, the coating with the carbon material by the CVD method made the reaction active sites dense and the reductive decomposition reaction of the solid electrolyte was suppressed, and thus a reduction in the cumulative irreversible capacity also occurred at the same time. In Comparative Example 10, the ratio R_{D/G} was low and thus the reaction active sites were sparse, and the cumulative irreversible capacity tended to increase due to the reductive decomposition of the solid electrolyte. It is inferred, however, that in Comparative Example 10, the heat treatment after the coating removed the remaining nitrogen and an increase in the cumulative irreversible capacity resulting from lithium nitride was suppressed, and thus the cumulative irreversible capacity was suppressed as a whole. Note that although an increase in the cumulative irreversible capacity was suppressed, the reaction resistance R_{A} increased significantly in Comparative Example 10.

Based on the above, it was found essential for the R_{D/G} to be 1.5 or more in order both to reduce the irreversible capacity resulting from the reductive decomposition of the solid electrolyte and to improve the load characteristics.

Next, using Comparative Example 11 described below in addition to Comparative Example 2, Comparative Example 6, Example 2, and Example 3, it was verified that the coating with the carbon material causes a decrease in the reversible capacity in the case where the ratio R_{D/G} exceeded 3.5 and in the case where the ratio of the mass of the carbon material to the mass of the coated active material exceeded 15%.

### [Evaluation of Physical Properties of Active Material]

The coated active material of Comparative Example 11 described below was measured for physical properties, such as the BET specific surface area, the ratio R_{D/G}, and the full width half maximum value Δv_{G}, by the measuring methods mentioned above.

### Comparative Example 11

The spheroidized natural graphite B serving as the core material was coated with the carbon material by the above-mentioned rotational flow CVD method. A gas mixture of ethane and nitrogen was used as the source gas. Conditions were set so that the ethane flow rate was 400 sccm, the nitrogen flow rate was 200 sccm, the pressure was 0.2 atmospheric pressure, the temperature was 850° C., and the processing time was 180 minutes. Thus, the coated active material of Comparative Example 11 was obtained. The ratio of the mass of the carbon material to the mass of the coated active material was 37.4%. The coated active material had a ratio R_{D/G} of 3.52 and a full width half maximum value Δv_{G} of 61.0 cm⁻¹ determined by Raman spectroscopy.

### [Evaluation of Cumulative Irreversible Capacity and Reversible Capacity Using Half Cell]

Using the coated active material of Comparative Example 11, two units of the half cells 200 (N=1, N=2) of Comparative Example 11 were produced in accordance with the above-mentioned production procedure. The produced half cells 200 were measured for the cumulative irreversible capacity and the reversible capacity in accordance with the above-mentioned method for measuring the cumulative irreversible capacity and the reversible capacity. In the half cells 200, the solid sulfide electrolyte A was used as the solid electrolyte included in the negative electrode active material layer 21.

The results obtained by the above measurements are shown in Table 5 together with the property values and the measured values of the cumulative irreversible capacity and the reversible capacity of Comparative Example 2, Comparative Example 6, Example 2, and Example 3 mentioned above.

TABLE 5

| | Comparative | | Comparative | | Comparative | | | | | |
|---|---|---|---|---|---|---|---|---|---|---|
| | Example 2 | | Example 6 | | Example 11 | | Example 2 | | Example 3 | |
| Negative electrode | Spheroidized | | Spheroidized | | Spheroidized | | Spheroidized | | Spheroidized | |
| active material | natural graphite B | | natural graphite B | | natural graphite B | | natural graphite B | | natural graphite B | |
| Method for coating | — | | Petroleum pitch | | Rotational flow | | Rotational flow | | Rotational flow | |
| with carbon | | | | | CVD method | | CVD method | | CVD method | |
| material | | | | | | | | | | |
| Median diameter | 15.8 | | 16.9 | | Approx. 16 | | Approx. 16 | | Approx. 16 | |
| [μm] | | | | | | | | | | |
| BET specific | 5.29 | | 2.29 | | 0.77 | | 2.98 | | 2.60 | |
| surface area | | | | | | | | | | |
| [m²/g] | | | | | | | | | | |
| Geometric specific | 0.16 | | 0.17 | | N/A | | 0.15 | | 0.16 | |
| surface area | | | | | | | | | | |
| [m²/g] | | | | | | | | | | |
| Ratio R_{D/G} | 0.73 | | 1.38 | | 3.52 | | 2.95 | | 2.91 | |
| Full width half | 19.6 | | 22.9 | | 61.0 | | 37.2 | | 55.8 | |
| maximum value | | | | | | | | | | |
| Δv_{G} [cm⁻¹] | | | | | | | | | | |
| Cumulative | 22.5 | 21.5 | 21.8 | 18.4 | 18.5 | 21.1 | 12.4 | 13.1 | 11.2 | 13.1 |
| irreversible capacity | (N = 1) | (N = 2) | (N = 1) | (N = 2) | (N = 1) | (N = 2) | (N = 1) | (N = 2) | (N = 1) | (N = 2) |
| [mAh/g] | | | | | | | | | | |
| Reversible capacity | 342.0 | 341.0 | 328.9 | 336.6 | 303.3 | 313.2 | 326.8 | 332.2 | 318.6 | 326.4 |
| [mAh/g] | (N = 1) | (N = 2) | (N = 1) | (N = 2) | (N = 1) | (N = 2) | (N = 1) | (N = 2) | (N = 1) | (N = 2) |

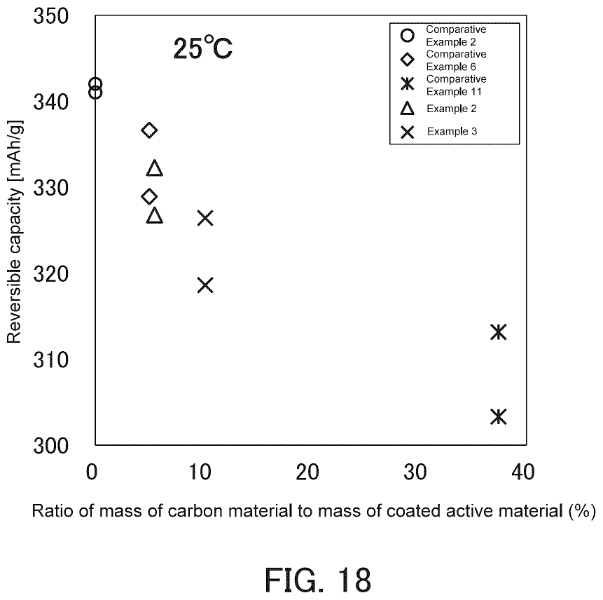

As for Comparative Example 2, Comparative Example 6, Comparative Example 11, Example 2, and Example 3, the relation between the ratio of the mass of the carbon material to the mass of the coated active material and the reversible capacity is shown in FIG. 18. As shown in FIG. 18, the reversible capacity decreased when the coating amount of the carbon material increased. Especially, the reversible capacity decreased significantly in Comparative Example 11 in which the ratio of the mass of the carbon material to the mass of the coated active material exceeded 15%.

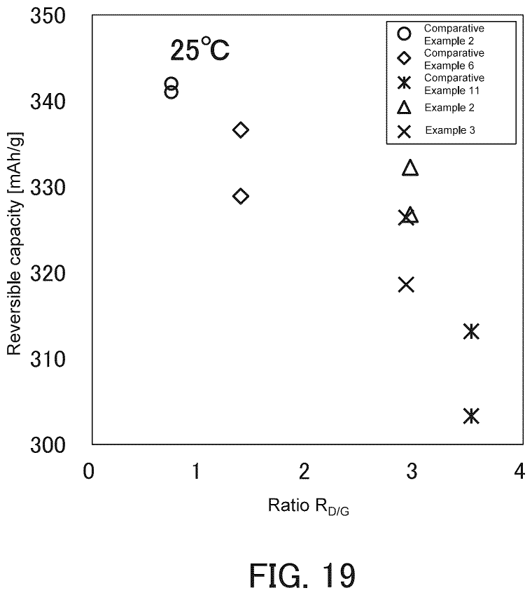

As for Comparative Example 2, Comparative Example 6, Comparative Example 11, Example 2, and Example 3, the relation between the ratio R_{D/G} and the reversible capacity is shown in FIG. 19. As shown in FIG. 19, the reversible capacity decreased significantly in Comparative Example 11 in which the ratio R_{D/G} was 3.52 and the ratio of the mass of the carbon material to the mass of the coated active material was 37.4% when compared to the reversible capacity in Example 3 in which the ratio R_{D/G} was 2.91 and the ratio of the mass of the carbon material to the mass of the coated active material was 10.2%.

Since it was desirable for the negative electrode active material to have a capacity of 310 mA/g or more per mass in the coated active material of the all-solid-state lithium-ion secondary battery, the above results ascertained that a decrease in the reversible capacity was suppressed when the ratio R_{D/G} was 3.5 or less and the ratio of the mass of the carbon material to the mass of the coated active material was less than 15%

### INDUSTRIAL APPLICABILITY

The all-solid-state lithium-ion secondary battery negative electrode and the all-solid-state lithium-ion secondary battery of the present disclosure are useful for electrical storage devices such as on-board lithium-ion secondary batteries.

What is claimed is:

1. A solid-state battery negative electrode comprising
a negative electrode active material layer, the negative electrode active material layer comprising a solid electrolyte, and a coated active material having a negative electrode active material and a carbon material coating at least a part of a surface of the negative electrode active material, wherein
when a Raman spectrum of the coated active material is measured by Raman spectroscopy,
a ratio R_{D/G} of an integrated intensity of D band to an integrated intensity of G band is 1.5 or more.

2. The solid-state battery negative electrode according to claim 1, wherein
the ratio R_{D/G} is 2.0 or more.

3. The solid-state battery negative electrode according to claim 1, wherein
the ratio R_{D/G} is 3.5 or less.

4. The solid-state battery negative electrode according to claim 1, wherein
a ratio of a mass of the carbon material to a mass of the coated active material is less than 15%.

5. The solid-state battery negative electrode according to claim 1, wherein
the coated active material has a BET specific surface area of more than 1.0 m²/g.

6. The solid-state battery negative electrode according to claim 1, wherein
the negative electrode active material comprises a graphite.

7. The solid-state battery negative electrode according to claim 1, wherein
a ratio of a volume of the coated active material to a volume of the negative electrode active material layer is 50% or more and less than 70%.

8. The solid-state battery negative electrode according to claim 1, wherein
the solid electrolyte comprises a solid sulfide electrolyte.

9. The solid-state battery negative electrode according to claim 8, wherein
the solid sulfide electrolyte comprises at least one selected from the group consisting of a Li₂S—P₂S₅-based glass-ceramic electrolyte and a solid argyrodite-type sulfide electrolyte.

10. A solid-state battery comprising:
a positive electrode;
a negative electrode; and
a solid electrolyte layer disposed between the positive electrode and the negative electrode, wherein
the negative electrode is the solid-state battery negative electrode according to claim 1.
